(19) United States
(12) Patent Application Publication
(10) Pub. No.: US 2026/0292469 A1
(43) Pub. Date: Sep. 24, 2026

(54) MOBILITY MANAGEMENT FOR AMBIENT-POWERED WIRELESS DEVICES

(71) Applicant: QUALCOMM Incorporated, San Diego, CA (US)

(72) Inventors: Luis Fernando Brisson LOPES, Swindon (GB); Yuchul KIM, San Diego, CA (US); Sebastian SPEICHER, Wallisellen (CH); Haris ZISIMOPOULOS, London (GB); Miguel GRIOT, La Jolla, CA (US); Olufunmilola Omolade AWONIYI-OTERI, San Diego, CA (US)

(21) Appl. No.: 19/475,708

(22) PCT Filed: May 31, 2024
(86) PCT No.: PCT/US2024/032077

§ 371 Date: Oct. 15, 2025

(30) Foreign Application Priority Data
Jun. 15, 2023 (GR) 20230100481

(51) Int. Cl. H04W 8/02; H04W 4/70; H04W 8/00; H04W 64/00; H04W 88/04

(52) U.S. Cl. CPC H04W 8/02; H04W 4/70; H04W 8/005; H04W 64/006; H04W 88/04

(57) ABSTRACT

Methods, systems, and devices for wireless communication are described. A mobility function network entity may transmit inventory request messages to reader wireless devices requesting that the readers report an inventory of ambientpowered wireless devices associated with each reader. The readers may request and receive information from the ambient-powerered wireless devices, and the readers may transmit inventory response messages to the mobility function network entity identifying the ambient-powered wireless devices and their associated information. The mobility function network entity may transmit a message to a first reader for relay to a first ambient-powered wireless device based on a first inventory response message that indicates that the first ambient-powered wireless device is associated with the first reader.

### CROSS REFERENCE

The present Application for Patent is a 371 national phase filing of International PCT Application No. PCT/US2024/032077 by LOPES et al., entitled “MOBILITY MANAGEMENT FOR AMBIENT-POWERED WIRELESS DEVICES,” filed May 31, 2024, and claims priority to and the benefit of Greece Patent Application No. 20230100481 by LOPES et al., entitled “MOBILITY MANAGEMENT FOR AMBIENT-POWERED WIRELESS DEVICES,” filed Jun. 15, 2023, each of which is assigned to the assignee hereof, and each of which is expressly incorporated by reference herein.

### TECHNICAL FIELD

The following relates generally to wireless communication, and more specifically to mobility management for ambient-powered wireless devices.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipments (UEs).

### SUMMARY

The described techniques relate to improved methods, systems, devices, and apparatuses that support mobility management for ambient-powered wireless devices. For example, a function (an ambient Internet-of-Things (A-IoT) Mobility Function (A-IMF)) may manage mobility management for ambient wireless devices. In some cases, an A-IMF may transmit inventory request messages to one or more reader wireless devices (e.g., readers) requesting that the reader wireless devices report an inventory of ambient wireless devices (e.g., A-IoTs) associated with that particular reader. Each reader wireless device may query the associated ambient wireless devices and receive query responses from the ambient wireless devices. Then, the reader wireless devices may transmit inventory response messages back to the A-IMF identifying the ambient wireless devices based on the query responses. The A-IMF may transmit a message to a respective reader wireless device (which is to be relayed to an ambient wireless device associated with that reader wireless device) indicating that the ambient wireless device is associated with the reader. In this way, the A-IMF (or another central node) may store ambient wireless device identifiers (IDs) and locations and interact with reader wireless devices to authenticate the ambient wireless device information.

A method for wireless communications at a mobility function network entity is described. The method may include transmitting a set of multiple inventory request messages to a set of multiple reader wireless devices requesting that the set of multiple reader wireless devices report an inventory of ambient-powered wireless devices associated with each reader wireless device, receiving, in response to the set of multiple inventory request messages, a set of multiple inventory response messages from the set of multiple reader wireless devices identifying a set of multiple ambient-powered wireless devices, and transmitting a message to a first reader wireless device for relay to a first ambient-powered wireless device based on a first inventory response message, of the set of multiple inventory response messages, the first inventory response message indicating that the first ambient-powered wireless device is associated with the first reader wireless device.

An apparatus for wireless communications at a mobility function network entity is described. The apparatus may include at least one processor, memory coupled (e.g., operatively, communicatively, functionally, electronically, or electrically) with the at least one processor, and instructions stored in the memory. The instructions may be executable by the at least one processor (e.g., directly, indirectly, after pre-processing, without pre-processing) to cause the apparatus to transmit a set of multiple inventory request messages to a set of multiple reader wireless devices requesting that the set of multiple reader wireless devices report an inventory of ambient-powered wireless devices associated with each reader wireless device, receive, in response to the set of multiple inventory request messages, a set of multiple inventory response messages from the set of multiple reader wireless devices identifying a set of multiple ambient-powered wireless devices, and transmit a message to a first reader wireless device for relay to a first ambient-powered wireless device based on a first inventory response message, of the set of multiple inventory response messages, the first inventory response message indicating that the first ambient-powered wireless device is associated with the first reader wireless device.

Another apparatus for wireless communications at a mobility function network entity is described. The apparatus may include means for transmitting a set of multiple inventory request messages to a set of multiple reader wireless devices requesting that the set of multiple reader wireless devices report an inventory of ambient-powered wireless devices associated with each reader wireless device, means for receiving, in response to the set of multiple inventory request messages, a set of multiple inventory response messages from the set of multiple reader wireless devices identifying a set of multiple ambient-powered wireless devices, and means for transmitting a message to a first reader wireless device for relay to a first ambient-powered wireless device based on a first inventory response message, of the set of multiple inventory response messages, the first inventory response message indicating that the first ambient-powered wireless device is associated with the first reader wireless device.

A non-transitory computer-readable medium storing code for wireless communications at a mobility function network entity is described. The code may include instructions executable by at least one processor (e.g., directly, indirectly, after pre-processing, without pre-processing) to transmit a set of multiple inventory request messages to a set of multiple reader wireless devices requesting that the set of multiple reader wireless devices report an inventory of ambient-powered wireless devices associated with each reader wireless device, receive, in response to the set of multiple inventory request messages, a set of multiple inventory response messages from the set of multiple reader wireless devices identifying a set of multiple ambient-powered wireless devices, and transmit a message to a first reader wireless device for relay to a first ambient-powered wireless device based on a first inventory response message, of the set of multiple inventory response messages, the first inventory response message indicating that the first ambient-powered wireless device is associated with the first reader wireless device.

Some examples of the method, apparatuses, and non-transitory computer-readable medium described herein may further include operations, features, means, or instructions for receiving, based on a set of multiple reflected messages of the set of multiple ambient-powered wireless devices, the set of multiple inventory response messages from the set of multiple reader wireless devices identifying the set of multiple ambient-powered wireless devices.

Some examples of the method, apparatuses, and non-transitory computer-readable medium described herein may further include operations, features, means, or instructions for receiving, based on a set of multiple announcement messages of the set of multiple ambient-powered wireless devices, a set of multiple second inventory response messages from the set of multiple reader wireless devices identifying the set of multiple ambient-powered wireless devices.

Some examples of the method, apparatuses, and non-transitory computer-readable medium described herein may further include operations, features, means, or instructions for transmitting one or more request messages to one or more reader wireless devices of the set of multiple reader wireless devices requesting that the one or more reader wireless devices report data for relay to an application function network entity, where the one or more reader wireless devices may be selected based on stored information associated with the set of multiple reader wireless devices, receiving, in response to the one or more request messages, one or more response messages from the one or more reader wireless devices identifying the data, and transmitting a message to the application function network entity based on the one or more response messages indicating the data.

In some examples of the method, apparatuses, and non-transitory computer-readable medium described herein, the one or more reader wireless devices may be selected based on a distance or signal strength between the one or more reader wireless devices and one or more of the set of multiple ambient-powered wireless devices.

Some examples of the method, apparatuses, and non-transitory computer-readable medium described herein may further include operations, features, means, or instructions for transmitting a message to an application function network entity indicating a location of the first reader wireless device, a location of the first ambient-powered wireless device, or both.

Some examples of the method, apparatuses, and non-transitory computer-readable medium described herein may further include operations, features, means, or instructions for storing information associated with the identified set of multiple ambient-powered wireless devices based on the set of multiple inventory response messages.

In some examples of the method, apparatuses, and non-transitory computer-readable medium described herein, the set of multiple inventory request messages indicate to suspend transmission of one or more of the set of multiple inventory response messages by one or more the set of multiple reader wireless devices for a time period or based on a trigger.

In some examples of the method, apparatuses, and non-transitory computer-readable medium described herein, the set of multiple inventory response messages indicate a set of multiple locations of the set of multiple reader wireless devices, a set of multiple reader wireless device IDs, and a set of multiple ambient-powered wireless device IDs.

Some examples of the method, apparatuses, and non-transitory computer-readable medium described herein may further include operations, features, means, or instructions for transmitting one or more of the set of multiple inventory request messages may be based on a traffic profile associated with one or more of the set of multiple ambient-powered wireless devices.

Some examples of the method, apparatuses, and non-transitory computer-readable medium described herein may further include operations, features, means, or instructions for storing a set of information associated with the identified set of multiple ambient-powered wireless devices, where the set of information includes power characteristics, energy storage capabilities, mobility characteristics, or any combination thereof.

In some examples of the method, apparatuses, and non-transitory computer-readable medium described herein, the set of multiple inventory request messages include a set of reporting parameters.

A method for wireless communications at a reader wireless device is described. The method may include receiving an inventory request message from a mobility function network entity requesting that the reader wireless device report an inventory of one or more ambient-powered wireless devices associated with the reader wireless device, transmitting, in response to the inventory request message, an inventory response message to the mobility function network entity identifying the inventory of the one or more ambient-powered wireless devices associated with the reader wireless device, receiving a message from the mobility function network entity for relay to a first ambient-powered wireless device based on the inventory response message indicating that the first ambient-powered wireless device is associated with the reader wireless device, and transmitting the message to the first ambient-powered wireless device.

An apparatus for wireless communications at a reader wireless device is described. The apparatus may include at least one processor, memory coupled (e.g., operatively, communicatively, functionally, electronically, or electrically) with the at least one processor, and instructions stored in the memory. The instructions may be executable by the at least one processor (e.g., directly, indirectly, after pre-processing, without pre-processing) to cause the apparatus to receive an inventory request message from a mobility function network entity requesting that the reader wireless device report an inventory of one or more ambient-powered wireless devices associated with the reader wireless device, transmit, in response to the inventory request message, an inventory response message to the mobility function network entity identifying the inventory of the one or more ambient-powered wireless devices associated with the reader wireless device, receive a message from the mobility function network entity for relay to a first ambient-powered wireless device based on the inventory response message indicating that the first ambient-powered wireless device is associated with the reader wireless device, and transmit the message to the first ambient-powered wireless device.

Another apparatus for wireless communications at a reader wireless device is described. The apparatus may include means for receiving an inventory request message from a mobility function network entity requesting that the reader wireless device report an inventory of one or more ambient-powered wireless devices associated with the reader wireless device, means for transmitting, in response to the inventory request message, an inventory response message to the mobility function network entity identifying the inventory of the one or more ambient-powered wireless devices associated with the reader wireless device, means for receiving a message from the mobility function network entity for relay to a first ambient-powered wireless device based on the inventory response message indicating that the first ambient-powered wireless device is associated with the reader wireless device, and means for transmitting the message to the first ambient-powered wireless device.

A non-transitory computer-readable medium storing code for wireless communications at a reader wireless device is described. The code may include instructions executable by at least one processor (e.g., directly, indirectly, after pre-processing, without pre-processing) to receive an inventory request message from a mobility function network entity requesting that the reader wireless device report an inventory of one or more ambient-powered wireless devices associated with the reader wireless device, transmit, in response to the inventory request message, an inventory response message to the mobility function network entity identifying the inventory of the one or more ambient-powered wireless devices associated with the reader wireless device, receive a message from the mobility function network entity for relay to a first ambient-powered wireless device based on the inventory response message indicating that the first ambient-powered wireless device is associated with the reader wireless device, and transmit the message to the first ambient-powered wireless device.

Some examples of the method, apparatuses, and non-transitory computer-readable medium described herein may further include operations, features, means, or instructions for transmitting one or more query messages to one or more ambient-powered wireless devices requesting information associated with the one or more ambient-powered wireless devices.

Some examples of the method, apparatuses, and non-transitory computer-readable medium described herein may further include operations, features, means, or instructions for transmitting the one or more query messages to the one or more ambient-powered wireless devices may be based on a movement of the reader wireless device, a movement of the one or more ambient-powered wireless devices, an environmental change, or a combination thereof.

Some examples of the method, apparatuses, and non-transitory computer-readable medium described herein may further include operations, features, means, or instructions for receiving, in response to the one or more query messages, one or more query response messages identifying the information associated with the one or more ambient-powered wireless devices, where the inventory response message includes the information.

In some examples of the method, apparatuses, and non-transitory computer-readable medium described herein, the one or more query messages indicate to suspend transmission of the one or more query response messages by the one or more ambient-powered wireless devices for a time period or based on a trigger.

Some examples of the method, apparatuses, and non-transitory computer-readable medium described herein may further include operations, features, means, or instructions for receiving one or more reflected messages from the one or more ambient-powered wireless devices and transmitting the inventory response message in response to receiving the one or more reflected messages.

Some examples of the method, apparatuses, and non-transitory computer-readable medium described herein may further include operations, features, means, or instructions for receiving one or more announcement messages from the one or more ambient-powered wireless devices and transmitting a second inventory response message to the mobility function network entity identifying the one or more ambient-powered wireless devices.

Some examples of the method, apparatuses, and non-transitory computer-readable medium described herein may further include operations, features, means, or instructions for receiving a first request message from the mobility function network entity requesting that the reader wireless device reports data for relay to an application function network entity, transmitting, in response to the first request message, one or more second request messages to the one or more ambient-powered wireless devices requesting the data, receiving, in response to the one or more second request messages, one or more first response messages from the one or more ambient-powered wireless devices identifying the data, and transmitting, in response to the one or more first response messages, a response message identifying the data.

In some examples of the method, apparatuses, and non-transitory computer-readable medium described herein, the first request message may be received based on a distance or signal strength between the reader wireless device and the one or more ambient-powered wireless devices.

In some examples of the method, apparatuses, and non-transitory computer-readable medium described herein, the inventory request message indicates to suspend transmission of the inventory response message by the reader wireless device for a time period or based on a trigger.

In some examples of the method, apparatuses, and non-transitory computer-readable medium described herein, the inventory request message indicates a location of the reader wireless device, a reader wireless device ID, and one or more ambient-powered wireless device IDs.

Some examples of the method, apparatuses, and non-transitory computer-readable medium described herein may further include operations, features, means, or instructions for receiving an indication of a traffic profile associated with the one or more ambient-powered wireless devices, where receiving the inventory request message may be based on the traffic profile.

In some examples of the method, apparatuses, and non-transitory computer-readable medium described herein, the inventory request message includes a set of reporting parameters.

A method for wireless communications at an ambient-powered wireless device is described. The method may include receiving a query message from a reader wireless device requesting that the ambient-powered wireless device report that the ambient-powered wireless device is associated with the reader wireless device, transmitting, in response to the query message, a query response message to the reader wireless device, the query response message reporting that the ambient-powered wireless device is associated with the reader wireless device, and receiving a message from the reader wireless device based on the query response message indicating that the ambient-powered wireless device is associated with the reader wireless device.

An apparatus for wireless communications at an ambient-powered wireless device is described. The apparatus may include at least one processor, memory coupled (e.g., operatively, communicatively, functionally, electronically, or electrically) with the at least one processor, and instructions stored in the memory. The instructions may be executable by the at least one processor (e.g., directly, indirectly, after pre-processing, without pre-processing) to cause the apparatus to receive a query message from a reader wireless device requesting that the ambient-powered wireless device report that the ambient-powered wireless device is associated with the reader wireless device, transmit, in response to the query message, a query response message to the reader wireless device, the query response message reporting that the ambient-powered wireless device is associated with the reader wireless device, and receive a message from the reader wireless device based on the query response message indicating that the ambient-powered wireless device is associated with the reader wireless device.

Another apparatus for wireless communications at an ambient-powered wireless device is described. The apparatus may include means for receiving a query message from a reader wireless device requesting that the ambient-powered wireless device report that the ambient-powered wireless device is associated with the reader wireless device, means for transmitting, in response to the query message, a query response message to the reader wireless device, the query response message reporting that the ambient-powered wireless device is associated with the reader wireless device, and means for receiving a message from the reader wireless device based on the query response message indicating that the ambient-powered wireless device is associated with the reader wireless device.

A non-transitory computer-readable medium storing code for wireless communications at an ambient-powered wireless device is described. The code may include instructions executable by at least one processor (e.g., directly, indirectly, after pre-processing, without pre-processing) to receive a query message from a reader wireless device requesting that the ambient-powered wireless device report that the ambient-powered wireless device is associated with the reader wireless device, transmit, in response to the query message, a query response message to the reader wireless device, the query response message reporting that the ambient-powered wireless device is associated with the reader wireless device, and receive a message from the reader wireless device based on the query response message indicating that the ambient-powered wireless device is associated with the reader wireless device.

In some examples of the method, apparatuses, and non-transitory computer-readable medium described herein, receiving the query message may include operations, features, means, or instructions for receiving the query message that requests information associated with the ambient-powered wireless device.

In some examples of the method, apparatuses, and non-transitory computer-readable medium described herein, transmitting the query response message may include operations, features, means, or instructions for transmitting, in response to the query message, the query response message identifying the information associated with the ambient-powered wireless device.

In some examples of the method, apparatuses, and non-transitory computer-readable medium described herein, the query message indicates to suspend transmission of the query response message by the ambient-powered wireless device for a time period ending based on a trigger.

Some examples of the method, apparatuses, and non-transitory computer-readable medium described herein may further include operations, features, means, or instructions for receiving a second query message from a second reader wireless device requesting second information associated with the ambient-powered wireless device based on an environmental change.

In some examples of the method, apparatuses, and non-transitory computer-readable medium described herein, transmitting the query response message may include operations, features, means, or instructions for transmitting the query response message that may be a backscattering of the query message.

Some examples of the method, apparatuses, and non-transitory computer-readable medium described herein may further include operations, features, means, or instructions for transmitting an announcement message to the reader wireless device, the announcement message identifying information associated with the ambient-powered wireless device based on expiration of a timer.

Some examples of the method, apparatuses, and non-transitory computer-readable medium described herein may further include operations, features, means, or instructions for receiving a request message from the reader wireless device requesting data for relay to a mobility function network entity and transmitting, in response to the request message, a response message to the reader wireless device identifying the data.

In some examples of the method, apparatuses, and non-transitory computer-readable medium described herein, the query message may be received based on a movement of the one or more ambient-powered wireless devices, a movement of the reader wireless device, an environmental change, or a combination thereof.

Some examples of the method, apparatuses, and non-transitory computer-readable medium described herein may further include operations, features, means, or instructions for transmitting an indication of a traffic profile associated with the ambient-powered wireless device, where receiving the query message may be based on the traffic profile.

In some examples of the method, apparatuses, and non-transitory computer-readable medium described herein, the query message includes a set of reporting parameters.

### BRIEF DESCRIPTION OF THE DRAWINGS

FIG. 1 shows an example of a wireless communications system that supports mobility management for ambient-powered wireless devices in accordance with one or more aspects of the present disclosure.

FIG. 2 shows an example of a network architecture that supports mobility management for ambient-powered wireless devices in accordance with one or more aspects of the present disclosure.

FIG. 3 shows an example of a wireless communications system that supports mobility management for ambient-powered wireless devices in accordance with one or more aspects of the present disclosure.

FIGS. 4 and 5 show examples of process flows that support mobility management for ambient-powered wireless devices in accordance with one or more aspects of the present disclosure.

FIGS. 6 and 7 show block diagrams of devices that support mobility management for ambient-powered wireless devices in accordance with one or more aspects of the present disclosure.

FIG. 8 shows a block diagram of a communications manager that supports mobility management for ambient-powered wireless devices in accordance with one or more aspects of the present disclosure.

FIG. 9 shows a diagram of a system including a device that supports mobility management for ambient-powered wireless devices in accordance with one or more aspects of the present disclosure.

FIGS. 10 and 11 show block diagrams of devices that support mobility management for ambient-powered wireless devices in accordance with one or more aspects of the present disclosure.

FIG. 12 shows a block diagram of a communications manager that supports mobility management for ambient-powered wireless devices in accordance with one or more aspects of the present disclosure.

FIG. 13 shows a diagram of a system including a device that supports mobility management for ambient-powered wireless devices in accordance with one or more aspects of the present disclosure.

FIGS. 14 and 15 show block diagrams of devices that support mobility management for ambient-powered wireless devices in accordance with one or more aspects of the present disclosure.

FIG. 16 shows a block diagram of a communications manager that supports mobility management for ambient-powered wireless devices in accordance with one or more aspects of the present disclosure.

FIG. 17 shows a diagram of a system including a device that supports mobility management for ambient-powered wireless devices in accordance with one or more aspects of the present disclosure.

FIGS. 18 through 24 show flowcharts illustrating methods that support mobility management for ambient-powered wireless devices in accordance with one or more aspects of the present disclosure.

### DETAILED DESCRIPTION

Ambient wireless devices (e.g., ambient Internet-of-Things (A-IoT) devices) are wireless devices that may have limited or no energy storage. Ambient wireless devices may lack the ability to perform autonomous transmissions, and as such, ambient wireless devices may communicate by reflecting received energy with some additional modulation carrying information (e.g., backscattering). In addition, ambient wireless devices may lack support for some mobility management procedures, including cell selection and reselection, and registration procedures, nor can such ambient wireless devices initiate communications with other wireless devices. In some cases, wireless devices such as user equipments (UEs) and network entities (e.g., base stations) may lack techniques for directing communications toward an ambient wireless device that does not follow the mobility management procedures when the UE, for example, moves out of a current registration area. In addition, techniques may be desired for selecting a UE, network entity, or other wireless node to communicate with a particular ambient wireless device.

The described techniques relate to improved methods, systems, devices, and apparatuses that support mobility management for ambient-powered wireless devices. For example, a function (an A-IoT Mobility Function (A-IMF)) may manage mobility management for ambient wireless devices. In some cases, an A-IMF may transmit inventory request messages to one or more reader wireless devices (e.g., readers) requesting that the reader wireless devices report an inventory of ambient wireless devices (e.g., A-IoTs) associated with that particular reader. The report may indicate that zero or more ambient wireless devices are associated with a particular reader. Each reader wireless device may transmit a query and receive zero or more query responses from the zero or more ambient wireless devices nearby to a particular reader. Then, the reader wireless devices may transmit inventory response messages back to the A-IMF identifying the zero or more ambient wireless devices based on the query responses or the absence of receiving any query responses. The A-IMF may transmit a message to a respective reader wireless device (which is to be relayed to an ambient wireless device associated with that reader wireless device) indicating that zero or more ambient wireless devices are associated with the reader. In this way, the A-IMF (or another central node) may store ambient wireless device identifiers (IDs) and locations and interact with reader wireless devices to authenticate the ambient wireless device information.

Aspects of the disclosure are initially described in the context of wireless communications systems. Aspects of the disclosure are then described in the context of network architectures and process flows. Aspects of the disclosure are further illustrated by and described with reference to apparatus diagrams, system diagrams, and flowcharts that relate to mobility management for ambient-powered wireless devices.

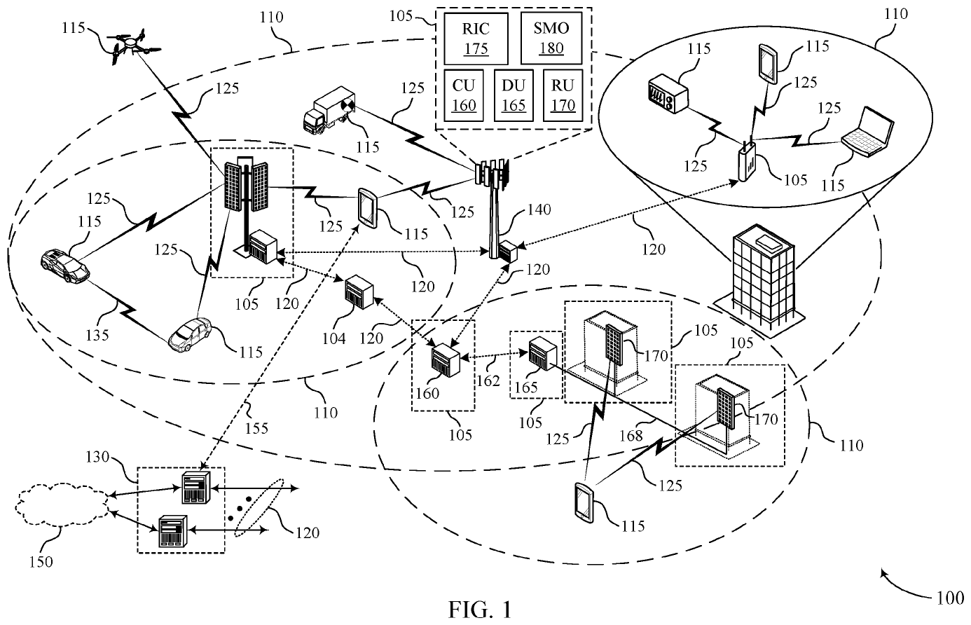

FIG. 1 shows an example of a wireless communications system 100 that supports mobility management for ambient-powered wireless devices in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

UEs 115 may be dispersed throughout the wireless communications system 100, and each UE 115 may be stationary or mobile. A UE 115 may also be referred to as a mobile device, a wireless device, a remote device, a handheld device, or a subscriber device, or some other suitable terminology, where the “device” may also be referred to as a unit, a station, a terminal, or a client. A UE 115 may be a device such as a cellular phone, a smart phone, a personal digital assistant (PDA), a multimedia/entertainment device (e.g., a radio, a MP3 player, or a video device), a camera, a gaming device, a navigation/positioning device (e.g., GNSS (global navigation satellite system) devices based on, for example, GPS (global positioning system), Beidou, GLONASS, or Galileo, or a terrestrial-based device), a tablet computer, a laptop computer, a netbook, a smartbook, a personal computer, a smart device, a wearable device (e.g., a smart watch, smart clothing, smart glasses, virtual reality goggles, a smart wristband, smart jewelry (e.g., a smart ring, a smart bracelet)), a drone, a robot/robotic device, a vehicle, a vehicular device, a meter (e.g., parking meter, electric meter, gas meter, water meter), a monitor, a gas pump, an appliance (e.g., kitchen appliance, washing machine, dryer), a location tag, a medical/healthcare device, an implant, a sensor/actuator, a display, or any other suitable device configured to communicate via a wireless or wired medium. In some examples, a UE 115 may also refer to a wireless local loop (WLL) station, an IoT device, an Internet of Everything (IoE) device, or an MTC device, or the like, which may be implemented in various articles such as appliances, drones, robots, vehicles, meters, or the like.

Some UEs 115, such as MTC or IoT devices, may be low cost or low complexity devices, and may provide for automated communication between machines (e.g., via Machine-to-Machine (M2M) communication). M2M communication or MTC may refer to data communication technologies that allow devices to communicate with one another or a network entity 105 (e.g., a base station) without human intervention. In some examples, M2M communication or MTC may include communications from devices that integrate sensors or meters to measure or capture information and relay that information to a central server or application program that can make use of the information or present the information to humans interacting with the program or application. Some UEs 115 may be designed to collect information or enable automated behavior of machines. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging. In an aspect, techniques disclosed herein may be applicable to MTC or IoT UEs. MTC or IoT UEs may include MTC/enhanced MTC (eMTC, also referred to as CAT-M, Cat M1) UEs, NB-IoT (also referred to as CAT NB1) UEs, as well as other types of UEs. eMTC and NB-IoT may refer to future technologies that may evolve from or may be based on these technologies. For example, eMTC may include FeMTC (further eMTC), eFeMTC (enhanced further eMTC), and mMTC (massive MTC), and NB-IoT may include eNB-IoT (enhanced NB-IoT), and FeNB-IoT (further enhanced NB-IoT).

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). A wireless network, for example a wireless local area network (WLAN), such as a Wi-Fi (e.g., Institute of Electrical and Electronics Engineers (IEEE) 802.11) network may include an access point (AP) that may communicate with one or more wireless or mobile devices. The AP may be coupled with a network, such as the Internet, and may enable a mobile device to communicate via the network (or communicate with other devices coupled with the AP). A wireless device may communicate with a network device bi-directionally. For example, in a WLAN, a device may communicate with an associated AP via downlink (e.g., the communication link from the AP to the device) and uplink (e.g., the communication link from the device to the AP). A wireless personal area network (PAN), which may include a Bluetooth connection, may provide for short range wireless connections between two or more paired wireless devices. For example, wireless devices such as cellular phones may utilize wireless PAN communications to exchange information such as audio signals with wireless headsets. Components within a wireless communication system may be coupled (for example, operatively, communicatively, functionally, electronically, and/or electrically) to each other.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, or a computing system may include disclosure of the UE 115, network entity 105, apparatus, device, or a computing system being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an AP, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (VIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support mobility management for ambient-powered wireless devices as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a PDA, a tablet computer, a laptop computer, or a personal computer. In some examples, a UE 115 may include or be referred to as a WLL station, an IoT device, an IoE device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given RAT (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δƒₘₐₓ·N_{ƒ}) seconds, for which Δƒₘₐₓ may represent a supported subcarrier spacing, and N_{ƒ} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{ƒ}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The wireless communications system 100 may support mobility management for ambient-powered wireless devices. For example, an A-IMF may manage mobility management for ambient wireless devices. In some cases, an A-IMF may transmit inventory request messages to one or more reader wireless devices (e.g., readers) requesting that the reader wireless devices report an inventory of ambient wireless devices (e.g., A-IoTs) associated with that particular reader. Each reader wireless device may query the associated ambient wireless devices and receive query responses from the ambient wireless devices. Then, the reader wireless devices may transmit inventory response messages back to the A-IMF identifying the ambient wireless devices based on the query responses. The A-IMF may transmit a message to a respective reader wireless device (which is to be relayed to an ambient wireless device associated with that reader wireless device) indicating that the ambient wireless device is associated with the reader. In this way, the A-IMF (or another central node) may store ambient wireless device IDs and locations and interact with reader wireless devices to authenticate the ambient wireless device information.

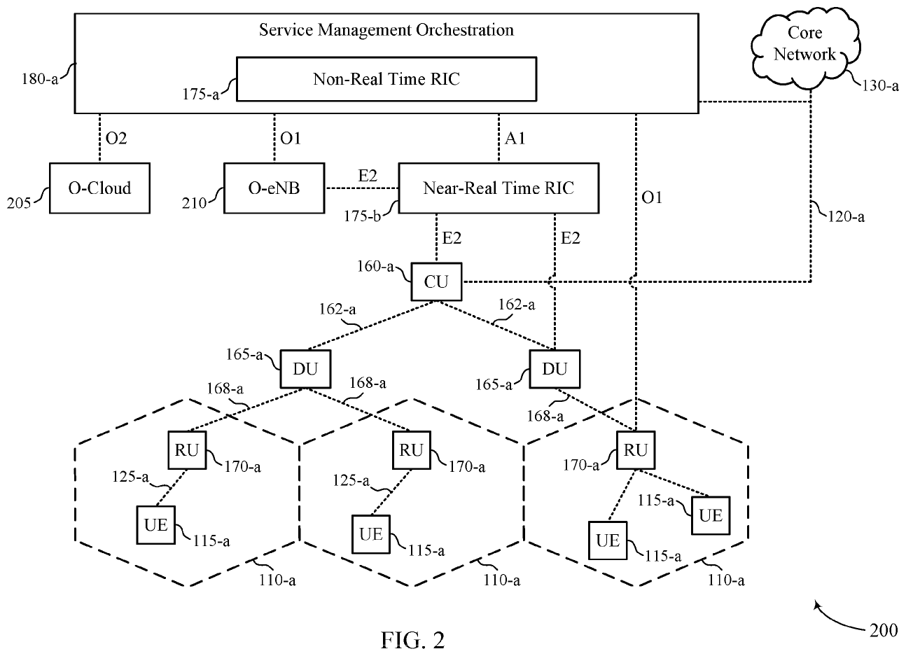

FIG. 2 shows an example of a network architecture 200 (e.g., a disaggregated base station architecture, a disaggregated RAN architecture) that supports mobility management for ambient-powered wireless devices in accordance with one or more aspects of the present disclosure. The network architecture 200 may illustrate an example for implementing one or more aspects of the wireless communications system 100. The network architecture 200 may include one or more CUs 160-a that may communicate directly with a core network 130-a via a backhaul communication link 120-a, or indirectly with the core network 130-a through one or more disaggregated network entities 105 (e.g., a Near-RT RIC 175-b via an E2 link, or a Non-RT RIC 175-a associated with an SMO 180-a (e.g., an SMO Framework), or both). A CU 160-a may communicate with one or more DUs 165-a via respective midhaul communication links 162-a (e.g., an F1 interface). The DUs 165-a may communicate with one or more RUs 170-a via respective fronthaul communication links 168-a. The RUs 170-a may be associated with respective coverage areas 110-a and may communicate with UEs 115-a via one or more communication links 125-a. In some implementations, a UE 115-a may be simultaneously served by multiple RUs 170-a.

Each of the network entities 105 of the network architecture 200 (e.g., CUs 160-a, DUs 165-a, RUs 170-a, Non-RT RICs 175-a, Near-RT RICs 175-b, SMOs 180-a, Open Clouds (O-Clouds) 205, Open eNBs (O-eNBs) 210) may include one or more interfaces or may be coupled with one or more interfaces configured to receive or transmit signals (e.g., data, information) via a wired or wireless transmission medium. Each network entity 105, or an associated processor (e.g., controller) providing instructions to an interface of the network entity 105, may be configured to communicate with one or more of the other network entities 105 via the transmission medium. For example, the network entities 105 may include a wired interface configured to receive or transmit signals over a wired transmission medium to one or more of the other network entities 105. Additionally, or alternatively, the network entities 105 may include a wireless interface, which may include a receiver, a transmitter, or transceiver (e.g., an RF transceiver) configured to receive or transmit signals, or both, over a wireless transmission medium to one or more of the other network entities 105.

In some examples, a CU 160-a may host one or more higher layer control functions. Such control functions may include RRC, PDCP, or SDAP. Each control function may be implemented with an interface configured to communicate signals with other control functions hosted by the CU 160-a. A CU 160-a may be configured to handle user plane functionality (e.g., CU-UP), control plane functionality (e.g., CU-CP), or a combination thereof. In some examples, a CU 160-a may be logically split into one or more CU-UP units and one or more CU-CP units. A CU-UP unit may communicate bidirectionally with the CU-CP unit via an interface, such as an El interface when implemented in an O-RAN configuration. A CU 160-a may be implemented to communicate with a DU 165-a, as necessary, for network control and signaling.

A DU 165-a may correspond to a logical unit that includes one or more functions (e.g., base station functions, RAN functions) to control the operation of one or more RUs 170-a. In some examples, a DU 165-a may host, at least partially, one or more of an RLC layer, a MAC layer, and one or more aspects of a PHY layer (e.g., a high PHY layer, such as modules for FEC encoding and decoding, scrambling, modulation and demodulation) depending, at least in part, on a functional split, such as those defined by the 3rd Generation Partnership Project (3GPP). In some examples, a DU 165-a may further host one or more low PHY layers. Each layer may be implemented with an interface configured to communicate signals with other layers hosted by the DU 165-a, or with control functions hosted by a CU 160-a.

In some examples, lower-layer functionality may be implemented by one or more RUs 170-a. For example, an RU 170-a, controlled by a DU 165-a, may correspond to a logical node that hosts RF processing functions, or low-PHY layer functions (e.g., performing fast Fourier transform (FFT), inverse FFT (iFFT), digital beamforming, physical random access channel (PRACH) extraction and filtering), or both, based at least in part on the functional split, such as a lower-layer functional split. In such an architecture, an RU 170-a may be implemented to handle over the air (OTA) communication with one or more UEs 115-a. In some implementations, real-time and non-real-time aspects of control and user plane communication with the RU(s) 170-a may be controlled by the corresponding DU 165-a. In some examples, such a configuration may enable a DU 165-a and a CU 160-a to be implemented in a cloud-based RAN architecture, such as a vRAN architecture.

The SMO 180-a may be configured to support RAN deployment and provisioning of non-virtualized and virtualized network entities 105. For non-virtualized network entities 105, the SMO 180-a may be configured to support the deployment of dedicated physical resources for RAN coverage requirements which may be managed via an operations and maintenance interface (e.g., an Ol interface). For virtualized network entities 105, the SMO 180-a may be configured to interact with a cloud computing platform (e.g., an O-Cloud 205) to perform network entity life cycle management (e.g., to instantiate virtualized network entities 105) via a cloud computing platform interface (e.g., an O2 interface). Such virtualized network entities 105 can include, but are not limited to, CUs 160-a, DUs 165-a, RUs 170-a, and Near-RT RICs 175-b. In some implementations, the SMO 180-a may communicate with components configured in accordance with a 4G RAN (e.g., via an Ol interface). Additionally, or alternatively, in some implementations, the SMO 180-a may communicate directly with one or more RUs 170-a via an O1 interface. The SMO 180-a also may include a Non-RT RIC 175-a configured to support functionality of the SMO 180-a.

The Non-RT RIC 175-a may be configured to include a logical function that enables non-real-time control and optimization of RAN elements and resources, Artificial Intelligence (AI) or Machine Learning (ML) workflows including model training and updates, or policy-based guidance of applications/features in the Near-RT RIC 175-b. The Non-RT RIC 175-a may be coupled with or communicate with (e.g., via an AI interface) the Near-RT RIC 175-b. The Near-RT RIC 175-b may be configured to include a logical function that enables near-real-time control and optimization of RAN elements and resources via data collection and actions over an interface (e.g., via an E2 interface) connecting one or more CUs 160-a, one or more DUs 165-a, or both, as well as an O-eNB 210, with the Near-RT RIC 175- b.

In some examples, to generate AI/ML models to be deployed in the Near-RT RIC 175-b, the Non-RT RIC 175-a may receive parameters or external enrichment information from external servers. Such information may be utilized by the Near-RT RIC 175-b and may be received at the SMO 180-a or the Non-RT RIC 175-a from non-network data sources or from network functions. In some examples, the Non-RT RIC 175-a or the Near-RT RIC 175-b may be configured to tune RAN behavior or performance. For example, the Non-RT RIC 175-a may monitor long-term trends and patterns for performance and employ AI or ML models to perform corrective actions through the SMO 180-a (e.g., reconfiguration via O1) or via generation of RAN management policies (e.g., Al policies).

The network architecture 200 may support mobility management for ambient-powered wireless devices. For example, an A-IMF may manage mobility management for ambient wireless devices. In some cases, an A-IMF may transmit inventory request messages to one or more reader wireless devices (e.g., readers) requesting that the reader wireless devices report an inventory of ambient wireless devices (e.g., A-IoTs) associated with that particular reader. Each reader wireless device may query the associated ambient wireless devices and receive query responses from the ambient wireless devices. Then, the reader wireless devices may transmit inventory response messages back to the A-IMF identifying the ambient wireless devices based on the query responses. The A-IMF may transmit a message to a respective reader wireless device (which is to be relayed to an ambient wireless device associated with that reader wireless device) indicating that the ambient wireless device is associated with the reader. In this way, the A-IMF (or another central node) may store ambient wireless device IDs and locations and interact with reader wireless devices to authenticate the ambient wireless device information.

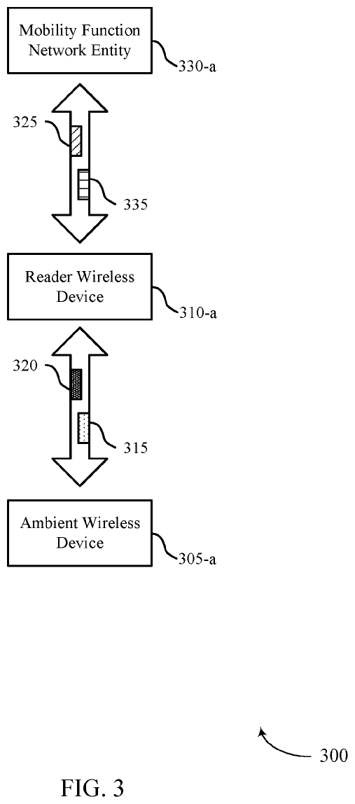

FIG. 3 shows an example of a wireless communications system 300 that supports mobility management for ambient-powered wireless devices in accordance with one or more aspects of the present disclosure. The wireless communications system may include an ambient wireless device 305-a (e.g., an A-IoT device), a reader wireless device 310-a (e.g., a reader), and a mobility function network entity 330-a (e.g., an A-IMF), which may be examples of corresponding devices described herein. In some examples, the mobility function network entity 330-a may communicate with multiple reader wireless devices 310 and each reader wireless device 310 may communicate with one or more ambient wireless devices 305.

The ambient wireless device 305-a may be an A-IoT device with either no energy storage or limited energy storage. For example, the ambient wireless device 305-a may be incapable of autonomous transmission, or capable of limited autonomous transmission. In place of or in addition to limited autonomous transmission, the ambient wireless device 305-a may communicate by reflecting received energy with some additional modulation carrying information (e.g., backscattering transmission). The ambient wireless device 305-a may lack support for some mobility management procedures, such as cell selection and reselection, system information block (SIB) reading, tracking area configuration, and network-attached storage (NAS) registration procedures.

The ambient wireless device 305-a may be one of multiple different types of A-IoT devices. The first device type (Type A) may have no energy storage and no independent signal generation (e.g., may use backscattering transmission). The second device type (Type B) may have limited energy storage (e.g., for amplification of reflected signals) and no independent signal generation (e.g., may use backscattering transmission). The third device type (Type C) may have limited energy storage (e.g., for amplification of reflected signals) and limited independent signal generation (e.g., an active RF component for transmission). In some examples, A-IoT devices of the third device type may be associated with a particular energy storage class. For example, a device capable of storing up to energies of E1/E2 Joules may have limited energy storage. Accordingly, a Type C device may in some cases be unable to autonomously transmit or reach a particular node for a complex procedure such as registration (e.g., due to a limited quantity of messages or limited size of messages).

The ambient wireless device 305-a may possess a subscriber identity module (SIM) and may be associated with a UE subscription. In addition, different wireless communication environments (e.g., RAN topologies) may support the ambient wireless device 305-a (e.g., communication towards a gNB or a network entity 105, a UE 115, or some other node acting as a relay or independently).

The ambient wireless device 305-a (particularly a Type A device or a Type B device) may have limited capability of initiating communications because of their limited energy storage capabilities. Other devices (e.g., network entities 105, UEs 115, or other wireless nodes) may have difficulty directing communications towards the ambient wireless device 305, since the ambient wireless device 305-a may not support standard mobility management procedures (e.g., cell reselection or registration procedures when moving from a current registration area to a new registration area). As such, methods may be desired to select a wireless device or node to communicate with the ambient wireless device 305-a (e.g., since the range of communication is likely to be much shorter for an A-IoT device than for a normal or typical mobile device).

In some examples, a reader wireless device 310-a may communicate and interact directly with the ambient wireless device 305. The reader wireless device 310-a may transmit and receive communication from other wireless devices and, in some cases, may additionally provide RF energy that may be used to power the ambient wireless device 305-a. In some examples, the reader wireless device 310-a may be a UE 115, a gNB or a network entity 105, an IAB node, another node in a 5G system, or a special-purpose node.

The reader wireless device 310-a may interrogate its environment by transmitting a query message 315 (e.g., a generic query). The reader wireless device 310-a may transmit the query messages 315 autonomously, via a configuration from a mobility function network entity 330, in response to detecting an environmental change for example. In some examples, such as when the ambient wireless device 305-a is a Type A or Type B device incapable of independent signal generation, the query message 315 may provide an uplink data transmission opportunity to the ambient wireless device 305-a.

In some examples, the query message 315 may indicate a specific ambient wireless device 305-a or set of ambient wireless devices 305-a that may use the query message 315 to transmit data (e.g., device information). In some examples, the reader wireless device 310-a may indicate a periodicity of the query messages 315 to the ambient wireless devices 305-a. In some examples, the ambient wireless device 305-a may provide the reader wireless device 310-a with traffic expectations that the reader wireless device 310-a may use to determine or modify the periodicity of the query messages 315. In some other examples, the mobility function network entity 330-a may configure the reader wireless device with a periodicity based on the traffic profile and characteristics of the ambient wireless device 305-a.

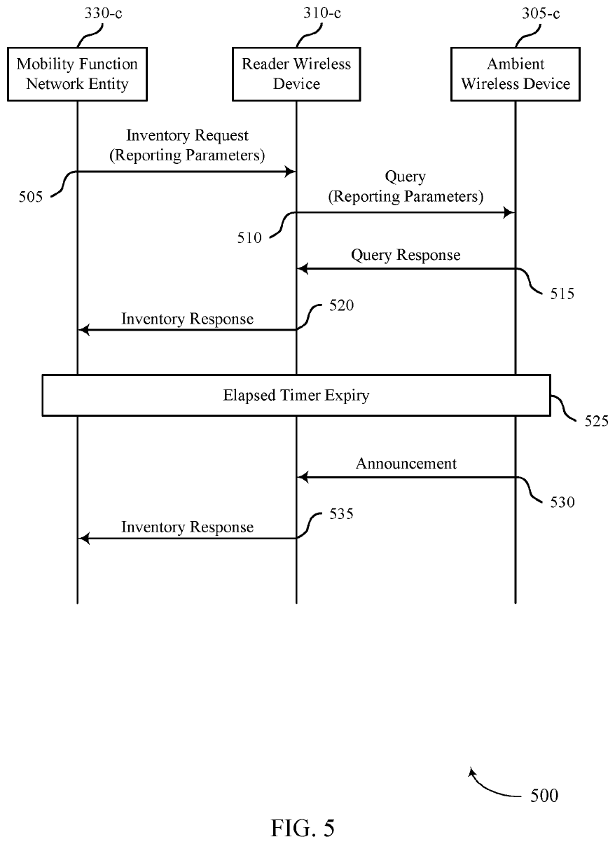

The ambient wireless device 305-a may respond to the query message 315 with a query response message 320 (e.g., via backscattering transmission) that may include ambient wireless device information, such as the device ID and other information about the ambient wireless device 305-a (e.g., sensor information or location information). In some examples (e.g., when the ambient wireless device 305-a is a Type C device capable of transmission), the ambient wireless device 305-a may autonomously transmit an announcement message to the reader wireless device 310, as described herein with reference to FIG. 5. The announcement message may include an indicator that the ambient wireless device 305-a has data (e.g., device information or sensor data) to transmit to the network. Additionally, or alternatively, the announcement message may include the data that the ambient wireless device 305-a is to transmit to the network. The reader wireless device 310-a may interact with the ambient wireless device 305-a to acknowledge the data, retrieve the data (e.g., via a query procedure), or both.

The reader wireless device 310-a may store the ambient wireless device information and/or may communicate the device information and its own location via inventory response message 325 to a central node, such as the mobility function network entity 330-a. The reader wireless device 310-a may interact (e.g., communicate) with the ambient wireless device 305-a and a server (e.g., the mobility function network entity 330-a) to authenticate the reported ambient wireless device ID.

The mobility function network entity 330-a may be an example of an AMF, another core network node, or an external server, and may be referred to as an A-IMF. In some examples, the mobility function network entity 330-a may reside in the licensed (e.g., 3GPP) core network (e.g., in an AMF), in the RAN, in an external server (e.g., external to 3GPP), or any combination thereof (e.g., some functionality may reside in the core network and some functionality may reside externally).

Exact signaling paths and transport may differ depending on whether or where the mobility function network entity 330-a and the reader wireless device 310-a are hosted. For example, the inventory request message 335, the inventory response message 325, or both may include user plane signaling transmitted to a UE 115 or may use control plane signaling transmitted to a network entity 105 (e.g., a gNB).

The mobility function network entity 330-a may possess some functionalities to support mobility management for ambient wireless devices 305-a. In some examples, the mobility function network entity 330-a may store, be configured with, or be able to access a database of characteristics of A-IoT devices (e.g., power characteristics, energy storage capability, or mobility characteristics). In some examples, the mobility function network entity 330-a may configure supporting reader wireless devices 310-a to collect and report data about ambient wireless devices 305-a in their surroundings (e.g., within a particular distance or vicinity, or with a sufficient signal strength). For instance, the mobility function network entity 330-a may transmit an inventory request message 335 to one or more reader wireless devices 310-a. In some examples, the mobility function network entity 330-a may receive reports (e.g., an inventory response message 325) from the one or more reader wireless devices 310-a that may include ambient wireless device information (e.g., A-IoT device location and A-IoT device ID), reader wireless device information (e.g., reader location and reader ID, such as UE ID if the reader wireless device 310-a is a UE 115 or a network node identity if the reader wireless device 310-a is a network entity 105), or any combination thereof. The mobility function network entity 330-a may store the received information, along with reader history (e.g., when the inventory response message 325 was transmitted or received), for example, in a database. The mobility function network entity 330-a may additionally support downlink and uplink communication, search functions, and communication with other wireless devices capable of transmission.

In some examples, other functions (e.g., application function network entities) may interact with the mobility function network entity 330-a to acquire information about the ambient wireless device 305-a in order to communicate with the ambient wireless device 305-a (e.g., to request data, request a fresh location report, or to transmit data such as a status change). In such examples, the mobility function network entity 330-a may act as a routing device, or the mobility function network entity 330-a may provide data for use by other functions.

When acting as a routing device, the mobility function network entity 330-a may select one or more suitable reader wireless devices 310-a based on the stored data (e.g., the last known reader wireless device 310, last known ambient wireless device 305-a location, or reader history). The mobility function network entity 330-a may forward the request to the one or more reader wireless devices 310-a and wait for a response. The one or more reader wireless devices 310-a may provide a device ID to ensure that other devices (e.g., ambient wireless devices 305-a other than the one with which the other function is communicating) do not respond. For example, if the mobility function network entity 330-a is routing to or inquiring about a specific ambient wireless device 305, the reader wireless device 310-a may include the device ID for that specific ambient wireless device 305-a in the query message 315 such that an ambient wireless device 305-a will transmit a query response message 320 only if its device ID matches the ID in the query message 315. If no response is received (e.g., during a duration after the request was transmitted), the mobility function network entity 330-a may loosen the reader selection criterion, for example, by selecting all reader wireless devices 310-a known to be within some distance of the last known location of the ambient wireless device 305-a (or known to have a sufficient signal strength with the ambient wireless device 305-a). Once a reader wireless device 310-a receives a suitable response from the target device (e.g., ambient wireless device 305-a), the reader wireless device 310-a may forward the response back to the mobility function network entity 330-a and the mobility function network entity 330-a may provide the received information to the originating function.

When providing data for use by one or more other functions (e.g., such that the other functions may communicate with the ambient wireless device 305-a), the mobility function network entity 330-a may provide reader location, ambient wireless device location, and other reader-related data for the target device (e.g., ambient wireless device 305-a). If the location data has not been updated for some time (e.g., is not sufficiently fresh), the mobility function network entity 330-a may follow the same steps described herein, but may refrain from forwarding data to the other function or functions. Instead, the mobility function network entity 330-a may transmit an acknowledgment of the presence and location of the ambient wireless device 305-a to the other function or functions.

In some examples, communications with the mobility function network entity 330-a may enable one or more other functions (e.g., application function network entities) to track the location of the ambient wireless device 305-a (e.g., for general purpose item tracking). In some examples, the mobility function network entity 330-a may receive an request message for ambient device information from a function. In response to the request message, the mobility function network entity 330-a may transmit, to the function, location and timestamp data associated with the ambient wireless device 305-a. The location and timestamp data may be based on the database of previous reports from the reader wireless device 310, and may include the previous location of the reader wireless device 310, the previous location of the ambient wireless device 305-a (e.g., as determined by the reader wireless device 310-a), or both.

In some examples, the timestamp of the location data may not meet a threshold freshness (e.g., the location data may be outdated and therefore less useful to the other function requesting the information). In such examples, the mobility function network entity 330-a may initiate procedures (similar to procedures for transmitting data as a routing device) in order to provide updated location information to the other function. For example, the mobility function network entity 330-a may select one or more reader wireless devices 310-a based on the data stored in the database (e.g., a last known reader wireless device 310-a location, a last known ambient wireless device 305-a location, reader wireless device 310-a history). The mobility function network entity 330-a may forward the request message to the one or more selected reader wireless devices 310-a (e.g., via the inventory request message 335) and wait for a response. The one or more reader wireless devices 310-a may transmit a query message 315 requesting device information from one or more ambient wireless devices 305-a. In some examples, the query message 315 may include a device ID to ensure that other devices (e.g., ambient wireless devices 305-a other than the one for which the other function is requesting information) do not respond.

If the mobility function network entity 330-a does not receive a response (e.g., an inventory response message 325) within a period of time, the mobility function network entity 330-a may loosen the reader selection criterion. For example, the mobility function network entity 330-a may select all reader wireless devices 310-a known to be within a particular distance of the last known location of the ambient wireless device 305-a (or known to have at least a threshold signal strength with the ambient wireless device 305-a) and transmit an inventory request message 335 to the selected reader wireless devices 310-a. Once a reader wireless device 310-a receives a query response message 320 from an ambient wireless device 305, the reader wireless device 310-a may forward the data (e.g., ambient wireless device 305-a location, reader wireless device 310-a location, or both) to the mobility function network entity 330-a. The mobility function network entity 330-a may store the updated location information along with a timestamp in the database and may transmit a report to the other function including the updated location information and timestamp, along with other information.

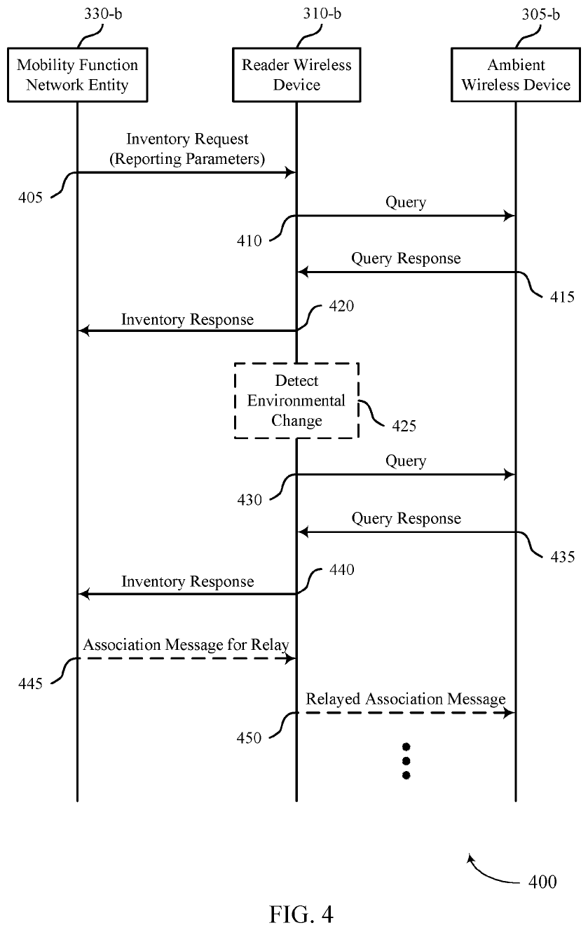

FIG. 4 shows an example of a process flow 400 that supports mobility management for ambient-powered wireless devices in accordance with one or more aspects of the present disclosure. In some examples, the process flow 400 may implement or be implemented by aspects of the wireless communications system 100, the network architecture 200, the wireless communications system 300, or any combination thereof. For example, the process flow 400 may include an ambient wireless device 305-b (e.g., an A-IoT device), a reader wireless device 310-b (e.g., a reader), and a mobility function network entity 330-b (e.g., an A-IMF), which may be examples of corresponding devices described herein with respect to FIG. 3. In some examples, the process flow 400 may include multiple ambient wireless devices 305 and multiple reader wireless devices 310. Alternative examples of the following may be implemented, where some steps are performed in a different order than described or are not performed at all. In some cases, steps may include additional features not mentioned below, or further steps may be added. Although the ambient wireless device 305-b, the reader wireless device 310-b, and the mobility function network entity 330-b are shown performing the operations of the process flow 400, some aspects of some operations may also be performed by one or more other wireless devices.

At 405, the mobility function network entity 330-b may transmit, to the reader wireless device 310-b, an inventory request message. In some examples, the inventory request message may configure the reader wireless device 310-b to provide an inventory of one or more ambient wireless devices 305-a. For example, the configuration may include reporting parameters (e.g., a reporting periodicity, movement of the reader wireless device 310-b, an event trigger, such as movement detection, change of local data such as sensor data, or other triggers).

At 410, the reader wireless device 310-b may transmit, to the ambient wireless device 305-b, a query message, for example, in response to the inventory request message received at 405. The reader wireless device 310-b may transmit the query message to all ambient wireless devices 305-a within an area or to a subset of ambient wireless devices 305. In some examples, the reader wireless device 310-b may periodically transmit a query message (e.g., according to the reporting periodicity configured by the mobility function network entity 330-b at 405).

At 415, the ambient wireless device 305-b may transmit, to the reader wireless device 310-b, a query response message (e.g., in response to the query message received at 410). The query response message may include ambient wireless device information, such as the device ID and other information (e.g., sensor information or location information). The reader wireless device 310-b may store the device information (along with other information, such as a timestamp) in a database. Other ambient wireless devices 305, if any, may also respond, at 415, to the query message, communicated at 410.

At 420, the reader wireless device 310-b may transmit, to the mobility function network entity 330-b, an inventory response message (e.g., in accordance with the reporting parameters provided at 405). The inventory response message may include the information obtained from the query response message at 415, and may, additionally, or alternatively, include information (e.g., location and ID) associated with the reader wireless device 310-b. The inventory response message may report information for one or more reader wireless devices 310.

At 425, the reader wireless device 310-b may detect an environmental change. For example, the reader wireless device 310-b may detect that it has moved to a new area, that one or more ambient wireless devices (e.g., ambient wireless device 305-b) have moved to new locations, that local data (such as sensor data) has changed, that the level of light or sound has changed, that other environmental changes have occurred, or any combination thereof.

At 430, the reader wireless device 310-b may transmit, to the ambient wireless device 305-b, an autonomously initiated query message (e.g., not in direct response to an inventory request message from the mobility function network entity 330-b). That is, the reader wireless device 310-b may autonomously initiate transmission of query messages. In some examples, the reader wireless device 310-b may transmit the query message based on detecting environmental changes at 425, or based on other reporting parameters/triggers received from the mobility function network entity 330-b at 405. In some examples, the reader wireless device 310-b may, additionally, or alternatively, transmit a message configuring the ambient wireless device 305-b to refrain from responding for a period of time or based on a trigger such as movement detection or a change of local data (e.g., sensor data).

At 435, the ambient wireless device 305-b may transmit, to the reader wireless device 310-b, a query response message, for example, in response to the query message received at 430. Similar to the query response message received at 415, the query response message may include ambient wireless device information, such as the device ID and other information (e.g., sensor information or location information). Other ambient wireless devices 305 may also respond to the query message with a query response message. The reader wireless device 310-b may store the device information (along with other information, such as a timestamp) in a database.

At 440, the reader wireless device 310-b may transmit, to the mobility function network entity, another inventory response message. In addition to the information obtained from the query response message at 435 and information about the reader wireless device 310-b, the inventory response message may include the results of multiple query response messages from the same ambient wireless device 305-b across time (e.g., a history of query response data, including timestamps). In some examples, the inventory response transmitted at 440 may include information about one or more ambient wireless devices 305. In some examples, the mobility function network entity 330-b may receive one or more inventory responses from each of one or more reader wireless devices 310.

At 445, the mobility function network entity 330-b may transmit, to the reader wireless device 310-b, an association message for relay to the ambient wireless device 305-b. In some examples, the mobility function network entity 330-b may transmit the association message based on or in response to receiving the inventory response from the reader wireless device 310-b at 420 or at 440. The association message may indicate an association between the ambient wireless device 305-b and the reader wireless device 310-b.

At 450, the reader wireless device 310-b may transmit, to the ambient wireless device 305-b, the relayed associated message (e.g., based on or in response to receiving the association message for relay from the mobility function network entity 330-b at 445). The association message may indicate an association between the ambient wireless device 305-b and the reader wireless device 310-b. In some examples, the ambient wireless device 305-b may transmit, to the reader wireless device 310-b, an acknowledgment message acknowledging that the ambient wireless device 305-b received the association message. In some examples, the reader wireless device 310-b may transmit, to the mobility function network entity 330-b, an acknowledgment message acknowledging that the ambient wireless device 305-b received the relayed association message.

FIG. 5 shows an example of a process flow 500 that supports mobility management for ambient-powered wireless devices in accordance with one or more aspects of the present disclosure. In some examples, the process flow 500 may implement or be implemented by aspects of the wireless communications system 100, the network architecture 200, the wireless communications system 300, or any combination thereof. For example, the process flow 500 may include an ambient wireless device 305-c (e.g., an A-IoT device), a reader wireless device 310-c (e.g., a reader), and a mobility function network entity 330-c (e.g., an A-IMF), which may be examples of corresponding devices described herein with respect to FIG. 3. In some examples, the process flow 500 may include multiple ambient wireless devices 305 and multiple reader wireless devices 310. Alternative examples of the following may be implemented, where some steps are performed in a different order than described or are not performed at all. In some cases, steps may include additional features not mentioned below, or further steps may be added. Although the ambient wireless device 305-c, the reader wireless device 310-c, and the mobility function network entity 330-c are shown performing the operations of the process flow 500, some aspects of some operations may also be performed by one or more other wireless devices.

At 505, the mobility function network entity 330-c may transmit, to the reader wireless device 310-c, an inventory request message. In some examples, the inventory request message may configure the reader wireless device 310-c to provide an inventory of one or more ambient wireless devices 305. For example, the configuration may include reporting parameters (e.g., a reporting periodicity, movement of the reader wireless device 310-b, or other triggers).

At 510, the reader wireless device 310-c may transmit, to the ambient wireless device 305-c, a query message, for example, in response to the inventory request message received at 505. In some examples, the reader wireless device 310-c may transmit the query message to all ambient wireless devices 305-a within an area or to a subset of ambient wireless devices 305. In some examples, the reader wireless device 310-c may periodically transmit a query message (e.g., according to the reporting periodicity configured by the mobility function network entity 330-b at 405) or may initiate query messages when triggered by another reporting parameter configured by the mobility function network entity 330-b at 405 (e.g., it detects nearby movement, change of lighting level, change in sound level, that it has moved to a new area, or another environmental change).

In some examples (e.g., if the ambient wireless device 305-c is a Type C device capable of autonomous transmission), the query message may include reporting parameters (e.g., a periodicity at which to transmit announcement messages, or one or more other triggers to transmit announcement messages, an event trigger, such as movement detection, change of local data such as sensor data, or other triggers), which may be the same as, similar to, or different from the reporting parameters received by the reader wireless device 310-c at 505. In some examples, the query message may include a timer and an indication to transmit an announcement message at the expiry of the timer. That is, the query message may configure the ambient wireless device 305-c to start a timer and to transmit an announcement message at the expiry of the timer. In some examples, the reader wireless device 310-c may configure the ambient wireless device 305-c to stop or start transmitting announcement messages, or to start or stop responding (e.g., for a time or based on a trigger such as movement detection or a change in local sensor data).

At 515, the ambient wireless device 305-c may transmit, to the reader wireless device 310-c, a query response message (e.g., in response to the query message received at 510). The query response message may include ambient wireless device information, such as the device ID and other information (e.g., sensor information or location information). The reader wireless device 310-c may store the device information (along with other information, such as a timestamp) in a database.

At 520, the reader wireless device 310-c may transmit, to the mobility function network entity 330-c, an inventory response message (e.g., in accordance with the reporting parameters provided at 505). The inventory response message may include the information obtained from the query response message at 515, and may, additionally, or alternatively, include information about the reader wireless device 310-c. The inventory response message may report information for one or more reader wireless devices 310.

At 525, an elapsed timer may expire (e.g., the timer transmitted at 510). In some examples, another trigger may occur (e.g., a trigger specified by the reporting parameters at 510, such as the ambient wireless device 305-c detecting a change in location).

The ambient wireless device 305-c may autonomously (e.g., in addition to responding directly to the initial query message at 510) initiate transmissions (e.g., because it is a Type C device). For example, at 530, the ambient wireless device 305-c may transmit, to the reader wireless device 310-c, an announcement message (e.g., in response to the timer expiry at 525 or another reporting parameter/trigger). The ambient wireless device 305-c may transmit the announcement according to the reporting parameters received by the ambient wireless device 305-c via the query message at 510. The ambient wireless device 305-c may use its limited energy storage to transmit the announcement, instead of a backscattered or reflected message. The announcement message may include ambient wireless device information, such as the device ID, device status, and other peripheral information (e.g., sensor information or location information). The reader wireless device 310-c may store the device information (along with other information, such as a timestamp) in a database. In some cases, the announcement message may include an indication that the ambient wireless device 305-c has data to transmit to the network, but may not include the data. In such cases, the reader wireless device 310-c may initiate a query procedure to retrieve the data from the ambient wireless device 305-c.

In some examples, the reader wireless device 310-c may transmit, to the ambient wireless device 305-c, an acknowledgment message acknowledging that the reader wireless device 310-c received the announcement message at 530. In some examples, the ambient wireless device 305-c may be configured (e.g., by the reporting parameters received at 510) to repeat transmission of the announcement message (or a query response message) until the ambient wireless device 305-c receives an acknowledgment. In some examples, the ambient wireless device 305-c may repeat transmission of the announcement message or query response message until more than one or all of the reader wireless devices 310-c in the area respond with an acknowledgment message.

At 535, the reader wireless device 310-c may transmit, to the mobility function network entity 330-c, an inventory response message, in some cases, in response to the announcement message at 530. In addition to the information obtained from the announcement message at 530 and information about the reader wireless device 310-c (e.g., reader location and reader ID), the inventory response message may include the results of multiple query response messages from the same ambient wireless device 305-c across time (e.g., a history of query response data, including a list of the device IDs and timestamps of query response messages and/or announcement messages, where in some examples the list may be empty due to not receiving a query response from any ambient wireless devices). In some examples, the inventory response transmitted at 535 may include information about one or more ambient wireless devices 305. In some examples, the mobility function network entity 330-c may receive one or more inventory responses from each of one or more reader wireless devices 310.

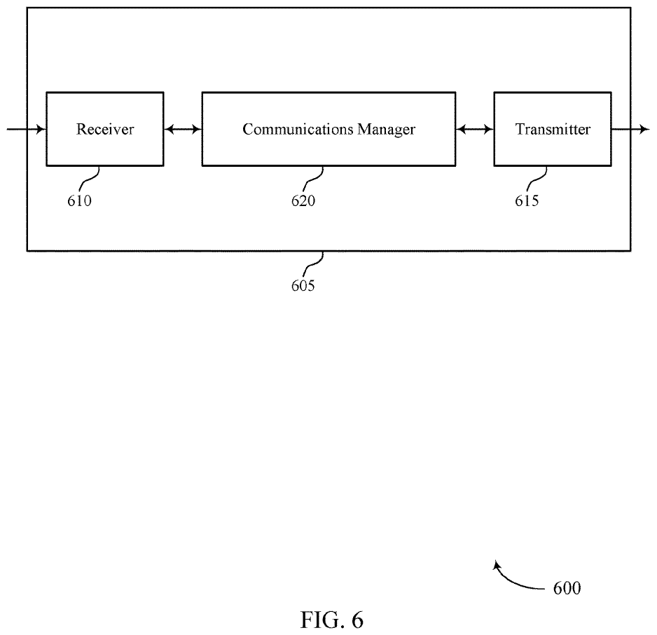

FIG. 6 shows a block diagram 600 of a device 605 that supports mobility management for ambient-powered wireless devices in accordance with one or more aspects of the present disclosure. The device 605 may be an example of aspects of a mobility function network entity as described herein. The device 605 may include a receiver 610, a transmitter 615, and a communications manager 620. The device 605, or one or more components of the device 605 (e.g., the receiver 610, the transmitter 615, and the communications manager 620), may include at least one processor, which may be coupled with at least one memory, to, individually or collectively, support or enable the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to mobility management for ambient-powered wireless devices). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to mobility management for ambient-powered wireless devices). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of mobility management for ambient-powered wireless devices as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a digital signal processor (DSP), a central processing unit (CPU), a graphics processing unit (GPU), an application specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in hardware, software (e.g., executed by at least one processor), or any combination thereof. If implemented in code executed by at least one processor, the functions of the communications manager 620, the receiver 610, the transmitter 615, or various combinations or components thereof may be performed by a general-purpose processor, a DSP, a CPU, a GPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications at a mobility function network entity in accordance with examples as disclosed herein. For example, the communications manager 620 is capable of, configured to, or operable to support a means for transmitting a set of multiple inventory request messages to a set of multiple reader wireless devices requesting that the set of multiple reader wireless devices report an inventory of ambient-powered wireless devices associated with each reader wireless device. The communications manager 620 is capable of, configured to, or operable to support a means for receiving, in response to the set of multiple inventory request messages, a set of multiple inventory response messages from the set of multiple reader wireless devices identifying a set of multiple ambient-powered wireless devices. The communications manager 620 is capable of, configured to, or operable to support a means for transmitting a message to a first reader wireless device for relay to a first ambient-powered wireless device based on a first inventory response message, of the set of multiple inventory response messages, the first inventory response message indicating that the first ambient-powered wireless device is associated with the first reader wireless device.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for mobility management for ambient-powered wireless devices, which may support reduced power consumption, reduced processing, more efficient utilization of communication resources, improved coordination between devices, and improved reliability.

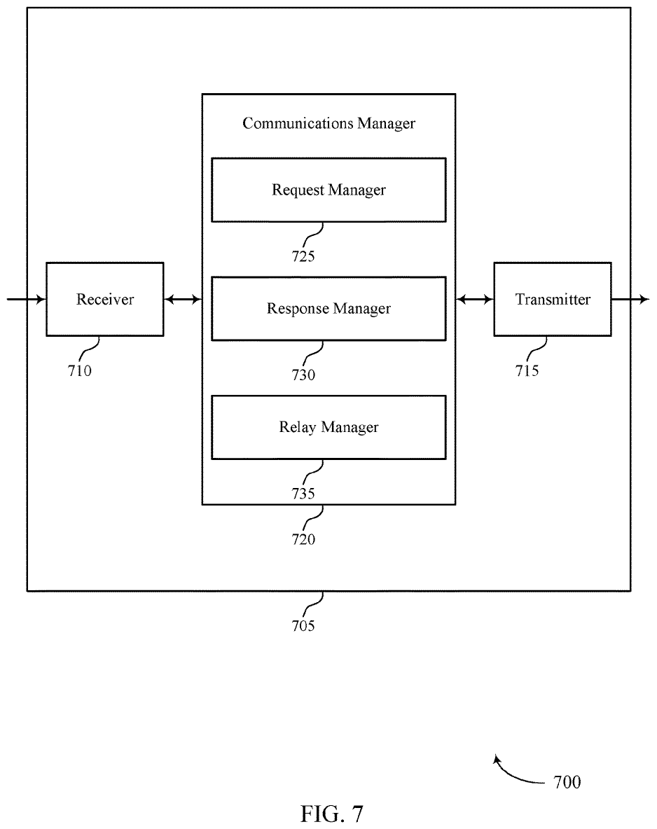

FIG. 7 shows a block diagram 700 of a device 705 that supports mobility management for ambient-powered wireless devices in accordance with one or more aspects of the present disclosure. The device 705 may be an example of aspects of a device 605 or a mobility function network entity as described herein. The device 705 may include a receiver 710, a transmitter 715, and a communications manager 720. The device 705, or one or more components of the device 705 (e.g., the receiver 710, the transmitter 715, and the communications manager 720), may include at least one processor, which may be coupled with at least one memory, to support the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to mobility management for ambient-powered wireless devices). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to mobility management for ambient-powered wireless devices). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of mobility management for ambient-powered wireless devices as described herein. For example, the communications manager 720 may include a request manager 725, a response manager 730, a relay manager 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications at a mobility function network entity in accordance with examples as disclosed herein. The request manager 725 is capable of, configured to, or operable to support a means for transmitting a set of multiple inventory request messages to a set of multiple reader wireless devices requesting that the set of multiple reader wireless devices report an inventory of ambient-powered wireless devices associated with each reader wireless device. The response manager 730 is capable of, configured to, or operable to support a means for receiving, in response to the set of multiple inventory request messages, a set of multiple inventory response messages from the set of multiple reader wireless devices identifying a set of multiple ambient-powered wireless devices. The relay manager 735 is capable of, configured to, or operable to support a means for transmitting a message to a first reader wireless device for relay to a first ambient-powered wireless device based on a first inventory response message, of the set of multiple inventory response messages, the first inventory response message indicating that the first ambient-powered wireless device is associated with the first reader wireless device.

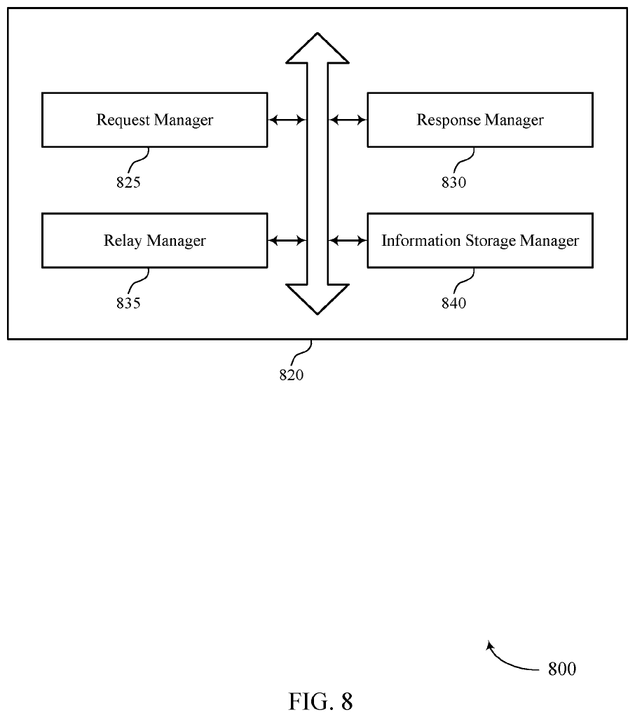

FIG. 8 shows a block diagram 800 of a communications manager 820 that supports mobility management for ambient-powered wireless devices in accordance with one or more aspects of the present disclosure. The communications manager 820 may be an example of aspects of a communications manager 620, a communications manager 720, or both, as described herein. The communications manager 820, or various components thereof, may be an example of means for performing various aspects of mobility management for ambient-powered wireless devices as described herein. For example, the communications manager 820 may include a request manager 825, a response manager 830, a relay manager 835, an information storage manager 840, or any combination thereof. Each of these components, or components or subcomponents thereof (e.g., one or more processors, one or more memories), may communicate, directly or indirectly, with one another (e.g., via one or more buses).

The communications manager 820 may support wireless communications at a mobility function network entity in accordance with examples as disclosed herein. The request manager 825 is capable of, configured to, or operable to support a means for transmitting a set of multiple inventory request messages to a set of multiple reader wireless devices requesting that the set of multiple reader wireless devices report an inventory of ambient-powered wireless devices associated with each reader wireless device. The response manager 830 is capable of, configured to, or operable to support a means for receiving, in response to the set of multiple inventory request messages, a set of multiple inventory response messages from the set of multiple reader wireless devices identifying a set of multiple ambient-powered wireless devices. The relay manager 835 is capable of, configured to, or operable to support a means for transmitting a message to a first reader wireless device for relay to a first ambient-powered wireless device based on a first inventory response message, of the set of multiple inventory response messages, the first inventory response message indicating that the first ambient-powered wireless device is associated with the first reader wireless device.

In some examples, the response manager 830 is capable of, configured to, or operable to support a means for receiving, based on a set of multiple reflected messages of the set of multiple ambient-powered wireless devices, the set of multiple inventory response messages from the set of multiple reader wireless devices identifying the set of multiple ambient-powered wireless devices.

In some examples, the response manager 830 is capable of, configured to, or operable to support a means for receiving, based on a set of multiple announcement messages of the set of multiple ambient-powered wireless devices, a set of multiple second inventory response messages from the set of multiple reader wireless devices identifying the set of multiple ambient-powered wireless devices.

In some examples, the request manager 825 is capable of, configured to, or operable to support a means for transmitting one or more request messages to one or more reader wireless devices of the set of multiple reader wireless devices requesting that the one or more reader wireless devices report data for relay to an application function network entity, where the one or more reader wireless devices are selected based on stored information associated with the set of multiple reader wireless devices. In some examples, the response manager 830 is capable of, configured to, or operable to support a means for receiving, in response to the one or more request messages, one or more response messages from the one or more reader wireless devices identifying the data. In some examples, the relay manager 835 is capable of, configured to, or operable to support a means for transmitting a message to the application function network entity based on the one or more response messages indicating the data.

In some examples, the one or more reader wireless devices are selected based on a distance or signal strength between the one or more reader wireless devices and one or more of the set of multiple ambient-powered wireless devices.

In some examples, the relay manager 835 is capable of, configured to, or operable to support a means for transmitting a message to an application function network entity indicating a location of the first reader wireless device, a location of the first ambient-powered wireless device, or both.

In some examples, the information storage manager 840 is capable of, configured to, or operable to support a means for storing information associated with the identified set of multiple ambient-powered wireless devices based on the set of multiple inventory response messages.

In some examples, the set of multiple inventory request messages indicate to suspend transmission of one or more of the set of multiple inventory response messages by one or more the set of multiple reader wireless devices for a time period or based on a trigger.

In some examples, the set of multiple inventory response messages indicate a set of multiple locations of the set of multiple reader wireless devices, a set of multiple reader wireless device Ids, and a set of multiple ambient-powered wireless device Ids.

In some examples, transmitting one or more of the set of multiple inventory request messages is based on a traffic profile associated with one or more of the set of multiple ambient-powered wireless devices.

In some examples, the information storage manager 840 is capable of, configured to, or operable to support a means for storing a set of information associated with the identified set of multiple ambient-powered wireless devices, where the set of information includes power characteristics, energy storage capabilities, mobility characteristics, or any combination thereof. In some examples, the set of multiple inventory request messages include a set of reporting parameters.

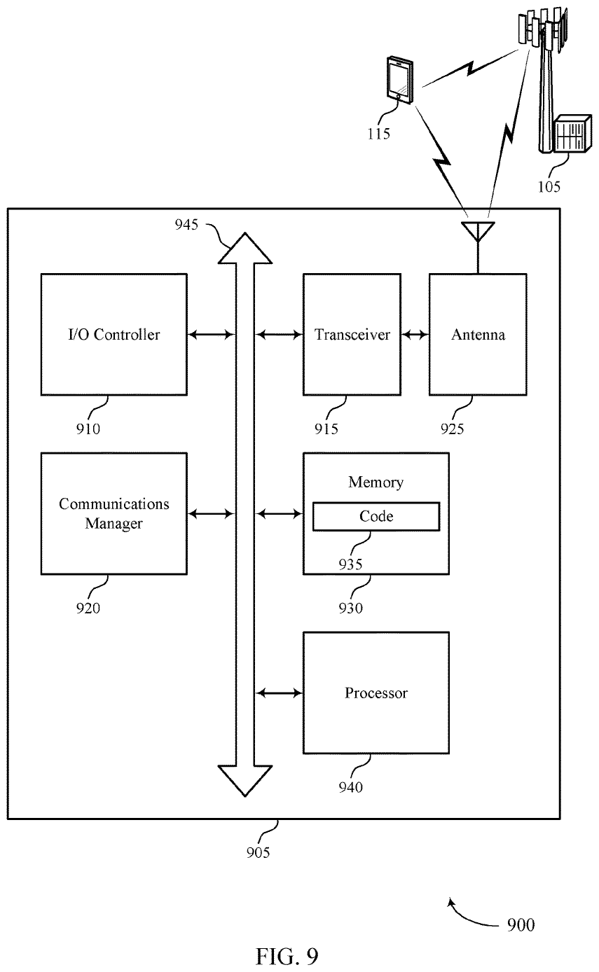

FIG. 9 shows a diagram of a system 900 including a device 905 that supports mobility management for ambient-powered wireless devices in accordance with one or more aspects of the present disclosure. The device 905 may be an example of or include the components of a device 605, a device 705, or a mobility function network entity as described herein. The device 905 may include components for bi-directional voice and data communications including components for transmitting and receiving communications, such as a communications manager 920, an I/O controller 910, a transceiver 915, an antenna 925, at least one memory 930, code 935, and at least one processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include RAM and ROM. The at least one memory 930 may store computer-readable, computer-executable code 935 including instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (e.g., when compiled and executed) to perform functions described herein. In some cases, the at least one memory 930 may contain, among other things, a BIOS which may control basic hardware or software operation such as the interaction with peripheral components or devices.

The at least one processor 940 may include an intelligent hardware device (e.g., a general-purpose processor, a DSP, a CPU, a GPU, a microcontroller, an ASIC, an FPGA, a programmable logic device, a discrete gate or transistor logic component, a discrete hardware component, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting mobility management for ambient-powered wireless devices). For example, the device 905 or a component of the device 905 may include at least one processor 940 and at least one memory 930 coupled with or to the at least one processor 940, the at least one processor 940 and at least one memory 930 configured to perform various functions described herein. In some examples, the at least one processor 940 may include multiple processors and the at least one memory 930 may include multiple memories. One or more of the multiple processors may be coupled with one or more of the multiple memories, which may, individually or collectively, be configured to perform various functions herein.

The communications manager 920 may support wireless communications at a mobility function network entity in accordance with examples as disclosed herein. For example, the communications manager 920 is capable of, configured to, or operable to support a means for transmitting a set of multiple inventory request messages to a set of multiple reader wireless devices requesting that the set of multiple reader wireless devices report an inventory of ambient-powered wireless devices associated with each reader wireless device. The communications manager 920 is capable of, configured to, or operable to support a means for receiving, in response to the set of multiple inventory request messages, a set of multiple inventory response messages from the set of multiple reader wireless devices identifying a set of multiple ambient-powered wireless devices. The communications manager 920 is capable of, configured to, or operable to support a means for transmitting a message to a first reader wireless device for relay to a first ambient-powered wireless device based on a first inventory response message, of the set of multiple inventory response messages, the first inventory response message indicating that the first ambient-powered wireless device is associated with the first reader wireless device.

By including or configuring the communications manager 920 in accordance with examples as described herein, the device 905 may support techniques for mobility management for ambient-powered wireless devices, which may support reduced power consumption, reduced processing, more efficient utilization of communication resources, improved coordination between devices, and improved reliability.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the at least one processor 940, the at least one memory 930, the code 935, or any combination thereof. For example, the code 935 may include instructions executable by the at least one processor 940 to cause the device 905 to perform various aspects of mobility management for ambient-powered wireless devices as described herein, or the at least one processor 940 and the at least one memory 930 may be otherwise configured to, individually or collectively, perform or support such operations.

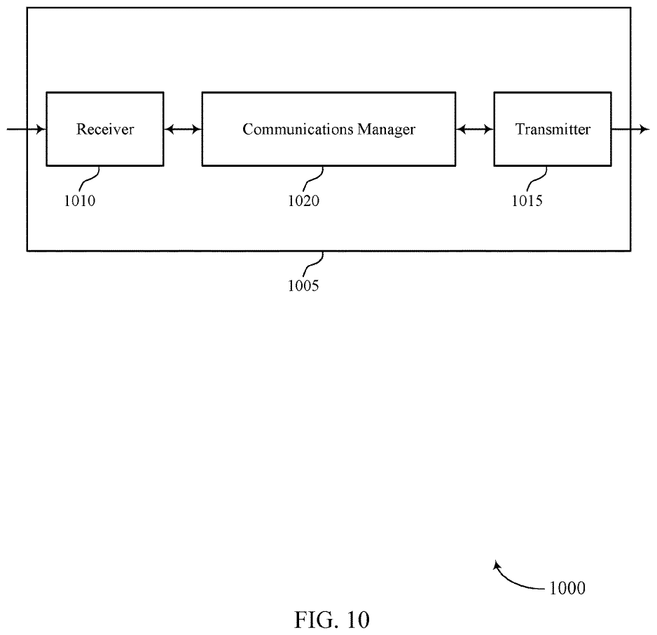

FIG. 10 shows a block diagram 1000 of a device 1005 that supports mobility management for ambient-powered wireless devices in accordance with one or more aspects of the present disclosure. The device 1005 may be an example of aspects of a reader wireless device as described herein. The device 1005 may include a receiver 1010, a transmitter 1015, and a communications manager 1020. The device 1005, or one or more components of the device 1005 (e.g., the receiver 1010, the transmitter 1015, and the communications manager 1020), may include at least one processor, which may be coupled with at least one memory, to, individually or collectively, support or enable the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations thereof or various components thereof may be examples of means for performing various aspects of mobility management for ambient-powered wireless devices as described herein. For example, the communications manager 1020, the receiver 1010, the transmitter 1015, or various combinations or components thereof may be capable of performing one or more of the functions described herein.

In some examples, the communications manager 1020, the receiver 1010, the transmitter 1015, or various combinations or components thereof may be implemented in hardware (e.g., in communications management circuitry). The hardware may include at least one of a processor, a DSP, a CPU, a GPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1020, the receiver 1010, the transmitter 1015, or various combinations or components thereof may be implemented in hardware, software (e.g., executed by at least one processor), or any combination thereof. If implemented in code executed by at least one processor, the functions of the communications manager 1020, the receiver 1010, the transmitter 1015, or various combinations or components thereof may be performed by a general-purpose processor, a DSP, a CPU, a GPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications at a reader wireless device in accordance with examples as disclosed herein. For example, the communications manager 1020 is capable of, configured to, or operable to support a means for receiving an inventory request message from a mobility function network entity requesting that the reader wireless device report an inventory of one or more ambient-powered wireless devices associated with the reader wireless device. The communications manager 1020 is capable of, configured to, or operable to support a means for transmitting, in response to the inventory request message, an inventory response message to the mobility function network entity identifying the inventory of the one or more ambient-powered wireless devices associated with the reader wireless device. The communications manager 1020 is capable of, configured to, or operable to support a means for receiving a message from the mobility function network entity for relay to a first ambient-powered wireless device based on the inventory response message indicating that the first ambient-powered wireless device is associated with the reader wireless device. The communications manager 1020 is capable of, configured to, or operable to support a means for transmitting the message to the first ambient-powered wireless device.

By including or configuring the communications manager 1020 in accordance with examples as described herein, the device 1005 (e.g., at least one processor controlling or otherwise coupled with the receiver 1010, the transmitter 1015, the communications manager 1020, or a combination thereof) may support techniques for mobility management for ambient-powered wireless devices, which may support reduced power consumption, reduced processing, more efficient utilization of communication resources, improved coordination between devices, and improved reliability.

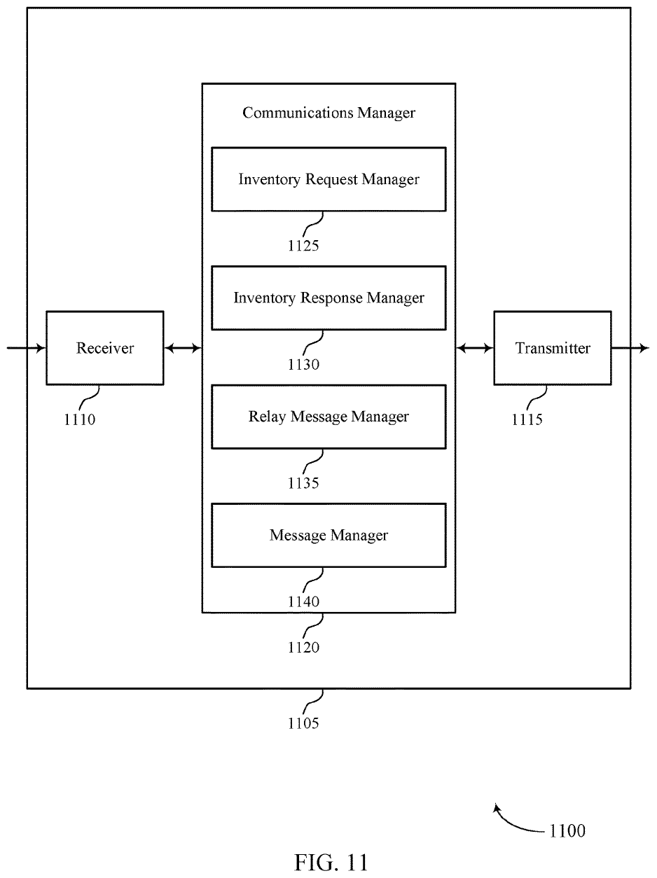

FIG. 11 shows a block diagram 1100 of a device 1105 that supports mobility management for ambient-powered wireless devices in accordance with one or more aspects of the present disclosure. The device 1105 may be an example of aspects of a device 1005 or a reader wireless device as described herein. The device 1105 may include a receiver 1110, a transmitter 1115, and a communications manager 1120. The device 1105, or one or more components of the device 1105 (e.g., the receiver 1110, the transmitter 1115, and the communications manager 1120), may include at least one processor, which may be coupled with at least one memory, to support the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of mobility management for ambient-powered wireless devices as described herein. For example, the communications manager 1120 may include an inventory request manager 1125, an inventory response manager 1130, a relay message manager 1135, a message manager 1140, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications at a reader wireless device in accordance with examples as disclosed herein. The inventory request manager 1125 is capable of, configured to, or operable to support a means for receiving an inventory request message from a mobility function network entity requesting that the reader wireless device report an inventory of one or more ambient-powered wireless devices associated with the reader wireless device. The inventory response manager 1130 is capable of, configured to, or operable to support a means for transmitting, in response to the inventory request message, an inventory response message to the mobility function network entity identifying the inventory of the one or more ambient-powered wireless devices associated with the reader wireless device. The relay message manager 1135 is capable of, configured to, or operable to support a means for receiving a message from the mobility function network entity for relay to a first ambient-powered wireless device based on the inventory response message indicating that the first ambient-powered wireless device is associated with the reader wireless device. The message manager 1140 is capable of, configured to, or operable to support a means for transmitting the message to the first ambient-powered wireless device.

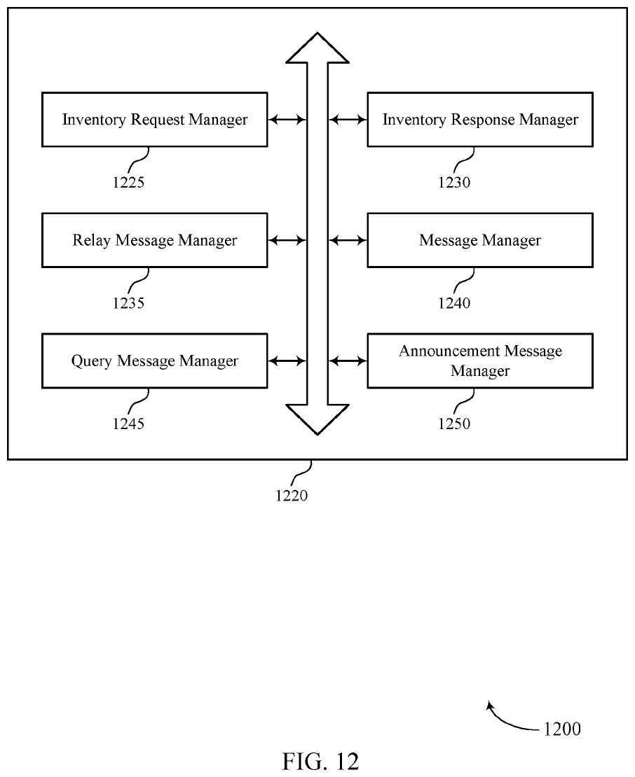

FIG. 12 shows a block diagram 1200 of a communications manager 1220 that supports mobility management for ambient-powered wireless devices in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of mobility management for ambient-powered wireless devices as described herein. For example, the communications manager 1220 may include an inventory request manager 1225, an inventory response manager 1230, a relay message manager 1235, a message manager 1240, a query message manager 1245, an announcement message manager 1250, or any combination thereof. Each of these components, or components or subcomponents thereof (e.g., one or more processors, one or more memories), may communicate, directly or indirectly, with one another (e.g., via one or more buses).

The communications manager 1220 may support wireless communications at a reader wireless device in accordance with examples as disclosed herein. The inventory request manager 1225 is capable of, configured to, or operable to support a means for receiving an inventory request message from a mobility function network entity requesting that the reader wireless device report an inventory of one or more ambient-powered wireless devices associated with the reader wireless device. The inventory response manager 1230 is capable of, configured to, or operable to support a means for transmitting, in response to the inventory request message, an inventory response message to the mobility function network entity identifying the inventory of the one or more ambient-powered wireless devices associated with the reader wireless device. The relay message manager 1235 is capable of, configured to, or operable to support a means for receiving a message from the mobility function network entity for relay to a first ambient-powered wireless device based on the inventory response message indicating that the first ambient-powered wireless device is associated with the reader wireless device. The message manager 1240 is capable of, configured to, or operable to support a means for transmitting the message to the first ambient-powered wireless device.

In some examples, the query message manager 1245 is capable of, configured to, or operable to support a means for transmitting one or more query messages to one or more ambient-powered wireless devices requesting information associated with the one or more ambient-powered wireless devices.

In some examples, transmitting the one or more query messages to the one or more ambient-powered wireless devices is based on a movement of the reader wireless device, a movement of the one or more ambient-powered wireless devices, an environmental change, or a combination thereof.

In some examples, the query message manager 1245 is capable of, configured to, or operable to support a means for receiving, in response to the one or more query messages, one or more query response messages identifying the information associated with the one or more ambient-powered wireless devices, where the inventory response message includes the information.

In some examples, the one or more query messages indicate to suspend transmission of the one or more query response messages by the one or more ambient-powered wireless devices for a time period or based on a trigger.

In some examples, the query message manager 1245 is capable of, configured to, or operable to support a means for receiving one or more reflected messages from the one or more ambient-powered wireless devices. In some examples, the inventory response manager 1230 is capable of, configured to, or operable to support a means for transmitting the inventory response message in response to receiving the one or more reflected messages.

In some examples, the announcement message manager 1250 is capable of, configured to, or operable to support a means for receiving one or more announcement messages from the one or more ambient-powered wireless devices. In some examples, the inventory response manager 1230 is capable of, configured to, or operable to support a means for transmitting a second inventory response message to the mobility function network entity identifying the one or more ambient-powered wireless devices.

In some examples, the inventory request manager 1225 is capable of, configured to, or operable to support a means for receiving a first request message from the mobility function network entity requesting that the reader wireless device reports data for relay to an application function network entity. In some examples, the query message manager 1245 is capable of, configured to, or operable to support a means for transmitting, in response to the first request message, one or more second request messages to the one or more ambient-powered wireless devices requesting the data. In some examples, the query message manager 1245 is capable of, configured to, or operable to support a means for receiving, in response to the one or more second request messages, one or more first response messages from the one or more ambient-powered wireless devices identifying the data. In some examples, the inventory response manager 1230 is capable of, configured to, or operable to support a means for transmitting, in response to the one or more first response messages, a response message identifying the data.

In some examples, the first request message is received based on a distance or signal strength between the reader wireless device and the one or more ambient-powered wireless devices. In some examples, the inventory request message indicates to suspend transmission of the inventory response message by the reader wireless device for a time period or based on a trigger.

In some examples, the inventory request message indicates a location of the reader wireless device, a reader wireless device ID, and one or more ambient-powered wireless device IDs.

In some examples, the inventory request manager 1225 is capable of, configured to, or operable to support a means for receiving an indication of a traffic profile associated with the one or more ambient-powered wireless devices, where receiving the inventory request message is based on the traffic profile. In some examples, the inventory request message includes a set of reporting parameters.

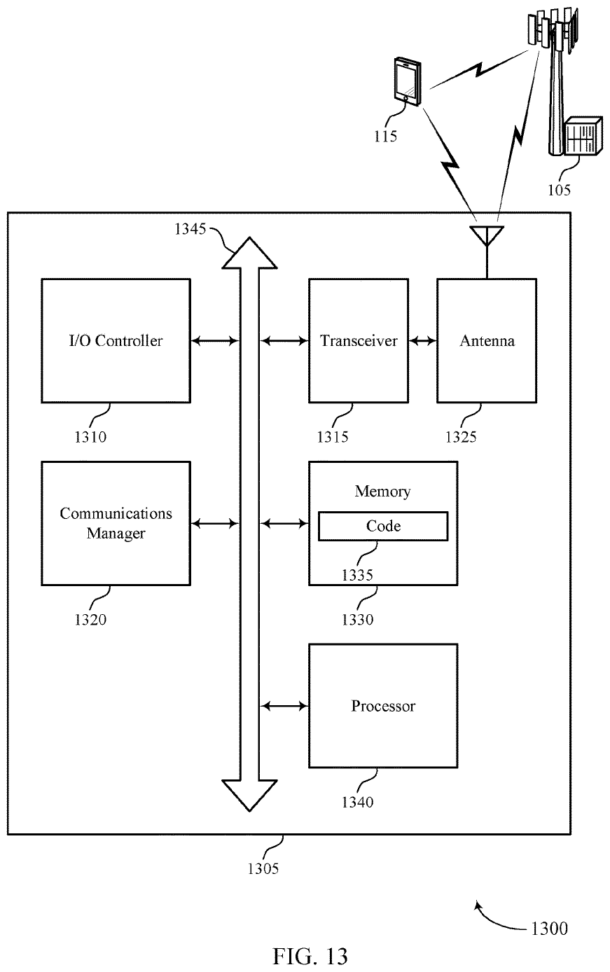

FIG. 13 shows a diagram of a system 1300 including a device 1305 that supports mobility management for ambient-powered wireless devices in accordance with one or more aspects of the present disclosure. The device 1305 may be an example of or include the components of a device 605, a device 705, or a mobility function network entity as described herein. The device 1305 may include components for bi-directional voice and data communications including components for transmitting and receiving communications, such as a communications manager 1320, an I/O controller 1310, a transceiver 1315, an antenna 1325, at least one memory 1330, code 1335, and at least one processor 1340. These components may be in electronic communication or otherwise coupled (e.g., operatively, communicatively, functionally, electronically, electrically) via one or more buses (e.g., a bus 1345).

The I/O controller 1310 may manage input and output signals for the device 1305. The I/O controller 1310 may also manage peripherals not integrated into the device 1305. In some cases, the I/O controller 1310 may represent a physical connection or port to an external peripheral. In some cases, the I/O controller 1310 may utilize an operating system such as iOS®, ANDROID®, MS-DOS®, MS-WINDOWS®, OS/2®, UNIX®, LINUX®, or another known operating system. Additionally, or alternatively, the I/O controller 1310 may represent or interact with a modem, a keyboard, a mouse, a touchscreen, or a similar device. In some cases, the I/O controller 1310 may be implemented as part of one or more processors, such as the at least one processor 1340. In some cases, a user may interact with the device 1305 via the I/O controller 1310 or via hardware components controlled by the I/O controller 1310.

In some cases, the device 1305 may include a single antenna 1325. However, in some other cases, the device 1305 may have more than one antenna 1325, which may be capable of concurrently transmitting or receiving multiple wireless transmissions. The transceiver 1315 may communicate bi-directionally, via the one or more antennas 1325, wired, or wireless links as described herein. For example, the transceiver 1315 may represent a wireless transceiver and may communicate bi-directionally with another wireless transceiver. The transceiver 1315 may also include a modem to modulate the packets, to provide the modulated packets to one or more antennas 1325 for transmission, and to demodulate packets received from the one or more antennas 1325. The transceiver 1315, or the transceiver 1315 and one or more antennas 1325, may be an example of a transmitter 615, a transmitter 715, a receiver 610, a receiver 710, or any combination thereof or component thereof, as described herein.

The at least one memory 1330 may include RAM and ROM. The at least one memory 1330 may store computer-readable, computer-executable code 1335 including instructions that, when executed by the at least one processor 1340, cause the device 1305 to perform various functions described herein. The code 1335 may be stored in a non-transitory computer-readable medium such as system memory or another type of memory. In some cases, the code 1335 may not be directly executable by the at least one processor 1340 but may cause a computer (e.g., when compiled and executed) to perform functions described herein. In some cases, the at least one memory 1330 may contain, among other things, a BIOS which may control basic hardware or software operation such as the interaction with peripheral components or devices.

The at least one processor 1340 may include an intelligent hardware device (e.g., a general-purpose processor, a DSP, a CPU, a GPU, a microcontroller, an ASIC, an FPGA, a programmable logic device, a discrete gate or transistor logic component, a discrete hardware component, or any combination thereof). In some cases, the at least one processor 1340 may be configured to operate a memory array using a memory controller. In some other cases, a memory controller may be integrated into the at least one processor 1340. The at least one processor 1340 may be configured to execute computer-readable instructions stored in a memory (e.g., the at least one memory 1330) to cause the device 1305 to perform various functions (e.g., functions or tasks supporting mobility management for ambient-powered wireless devices). For example, the device 1305 or a component of the device 1305 may include at least one processor 1340 and at least one memory 1330 coupled with or to the at least one processor 1340, the at least one processor 1340 and at least one memory 1330 configured to perform various functions described herein. In some examples, the at least one processor 1340 may include multiple processors and the at least one memory 1330 may include multiple memories. One or more of the multiple processors may be coupled with one or more of the multiple memories, which may, individually or collectively, be configured to perform various functions herein.

The communications manager 1320 may support wireless communications at a reader wireless device in accordance with examples as disclosed herein. For example, the communications manager 1320 is capable of, configured to, or operable to support a means for receiving an inventory request message from a mobility function network entity requesting that the reader wireless device report an inventory of one or more ambient-powered wireless devices associated with the reader wireless device. The communications manager 1320 is capable of, configured to, or operable to support a means for transmitting, in response to the inventory request message, an inventory response message to the mobility function network entity identifying the inventory of the one or more ambient-powered wireless devices associated with the reader wireless device. The communications manager 1320 is capable of, configured to, or operable to support a means for receiving a message from the mobility function network entity for relay to a first ambient-powered wireless device based on the inventory response message indicating that the first ambient-powered wireless device is associated with the reader wireless device. The communications manager 1320 is capable of, configured to, or operable to support a means for transmitting the message to the first ambient-powered wireless device.

By including or configuring the communications manager 1320 in accordance with examples as described herein, the device 1305 may support techniques for mobility management for ambient-powered wireless devices, which may support reduced power consumption, reduced processing, more efficient utilization of communication resources, improved coordination between devices, and improved reliability.

In some examples, the communications manager 1320 may be configured to perform various operations (e.g., receiving, monitoring, transmitting) using or otherwise in cooperation with the transceiver 1315, the one or more antennas 1325, or any combination thereof. Although the communications manager 1320 is illustrated as a separate component, in some examples, one or more functions described with reference to the communications manager 1320 may be supported by or performed by the at least one processor 1340, the at least one memory 1330, the code 1335, or any combination thereof. For example, the code 1335 may include instructions executable by the at least one processor 1340 to cause the device 1305 to perform various aspects of mobility management for ambient-powered wireless devices as described herein, or the at least one processor 1340 and the at least one memory 1330 may be otherwise configured to, individually or collectively, perform or support such operations.

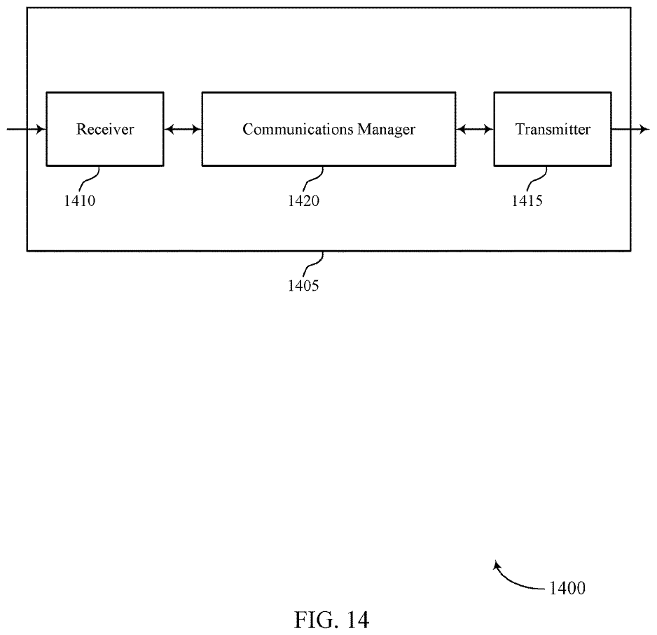

FIG. 14 shows a block diagram 1400 of a device 1405 that supports mobility management for ambient-powered wireless devices in accordance with one or more aspects of the present disclosure. The device 1405 may be an example of aspects of an ambient-powered wireless device as described herein. The device 1405 may include a receiver 1410, a transmitter 1415, and a communications manager 1420. The device 1405, or one or more components of the device 1405 (e.g., the receiver 1410, the transmitter 1415, and the communications manager 1420), may include at least one processor, which may be coupled with at least one memory, to, individually or collectively, support or enable the described techniques. Each of these components may be in communication with one another (e.g., via one or more buses).

The receiver 1410 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1405. In some examples, the receiver 1410 may support obtaining information by receiving signals via one or more antennas. Additionally, or alternatively, the receiver 1410 may support obtaining information by receiving signals via one or more wired (e.g., electrical, fiber optic) interfaces, wireless interfaces, or any combination thereof.

The transmitter 1415 may provide a means for outputting (e.g., transmitting, providing, conveying, sending) information generated by other components of the device 1405. For example, the transmitter 1415 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1415 may support outputting information by transmitting signals via one or more antennas. Additionally, or alternatively, the transmitter 1415 may support outputting information by transmitting signals via one or more wired (e.g., electrical, fiber optic) interfaces, wireless interfaces, or any combination thereof. In some examples, the transmitter 1415 and the receiver 1410 may be co-located in a transceiver, which may include or be coupled with a modem.

The communications manager 1420, the receiver 1410, the transmitter 1415, or various combinations thereof or various components thereof may be examples of means for performing various aspects of mobility management for ambient-powered wireless devices as described herein. For example, the communications manager 1420, the receiver 1410, the transmitter 1415, or various combinations or components thereof may be capable of performing one or more of the functions described herein.

In some examples, the communications manager 1420, the receiver 1410, the transmitter 1415, or various combinations or components thereof may be implemented in hardware (e.g., in communications management circuitry). The hardware may include at least one of a processor, a DSP, a CPU, a GPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1420, the receiver 1410, the transmitter 1415, or various combinations or components thereof may be implemented in hardware, software (e.g., executed by at least one processor), or any combination thereof. If implemented in code executed by at least one processor, the functions of the communications manager 1420, the receiver 1410, the transmitter 1415, or various combinations or components thereof may be performed by a general-purpose processor, a DSP, a CPU, a GPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1420 may be configured to perform various operations (e.g., receiving, obtaining, monitoring, outputting, transmitting) using or otherwise in cooperation with the receiver 1410, the transmitter 1415, or both. For example, the communications manager 1420 may receive information from the receiver 1410, send information to the transmitter 1415, or be integrated in combination with the receiver 1410, the transmitter 1415, or both to obtain information, output information, or perform various other operations as described herein.

The communications manager 1420 may support wireless communications at an ambient-powered wireless device in accordance with examples as disclosed herein. For example, the communications manager 1420 is capable of, configured to, or operable to support a means for receiving a query message from a reader wireless device requesting that the ambient-powered wireless device report that the ambient-powered wireless device is associated with the reader wireless device. The communications manager 1420 is capable of, configured to, or operable to support a means for transmitting, in response to the query message, a query response message to the reader wireless device, the query response message reporting that the ambient-powered wireless device is associated with the reader wireless device. The communications manager 1420 is capable of, configured to, or operable to support a means for receiving a message from the reader wireless device based on the query response message indicating that the ambient-powered wireless device is associated with the reader wireless device.

By including or configuring the communications manager 1420 in accordance with examples as described herein, the device 1405 (e.g., at least one processor controlling or otherwise coupled with the receiver 1410, the transmitter 1415, the communications manager 1420, or a combination thereof) may support techniques for mobility management for ambient-powered wireless devices, which may support reduced power consumption, reduced processing, more efficient utilization of communication resources, improved coordination between devices, and improved reliability.

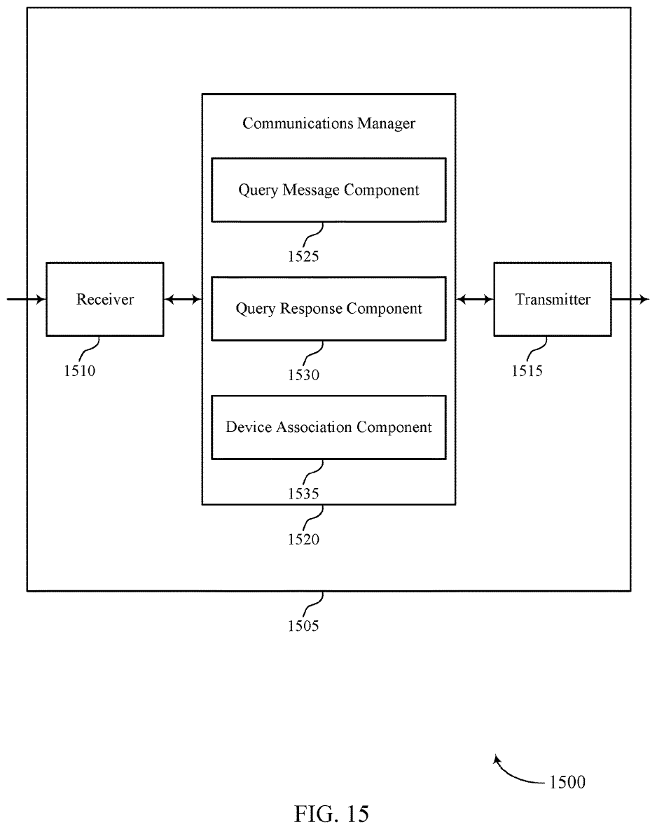

FIG. 15 shows a block diagram 1500 of a device 1505 that supports mobility management for ambient-powered wireless devices in accordance with one or more aspects of the present disclosure. The device 1505 may be an example of aspects of a device 1305 or an ambient-powered wireless device as described herein. The device 1505 may include a receiver 1510, a transmitter 1515, and a communications manager 1520. The device 1505, or one or more components of the device 1505 (e.g., the receiver 1510, the transmitter 1515, and the communications manager 1520), may include at least one processor, which may be coupled with at least one memory, to support the described techniques. Each of these components may be in communication with one another (e.g., via one or more buses).

The receiver 1510 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1505. In some examples, the receiver 1510 may support obtaining information by receiving signals via one or more antennas. Additionally, or alternatively, the receiver 1510 may support obtaining information by receiving signals via one or more wired (e.g., electrical, fiber optic) interfaces, wireless interfaces, or any combination thereof.

The transmitter 1515 may provide a means for outputting (e.g., transmitting, providing, conveying, sending) information generated by other components of the device 1505. For example, the transmitter 1515 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1515 may support outputting information by transmitting signals via one or more antennas. Additionally, or alternatively, the transmitter 1515 may support outputting information by transmitting signals via one or more wired (e.g., electrical, fiber optic) interfaces, wireless interfaces, or any combination thereof. In some examples, the transmitter 1515 and the receiver 1510 may be co-located in a transceiver, which may include or be coupled with a modem.

The device 1505, or various components thereof, may be an example of means for performing various aspects of mobility management for ambient-powered wireless devices as described herein. For example, the communications manager 1520 may include a query message component 1525, a query response component 1530, a device association component 1535, or any combination thereof. The communications manager 1520 may be an example of aspects of a communications manager 1320 as described herein. In some examples, the communications manager 1520, or various components thereof, may be configured to perform various operations (e.g., receiving, obtaining, monitoring, outputting, transmitting) using or otherwise in cooperation with the receiver 1510, the transmitter 1515, or both. For example, the communications manager 1520 may receive information from the receiver 1510, send information to the transmitter 1515, or be integrated in combination with the receiver 1510, the transmitter 1515, or both to obtain information, output information, or perform various other operations as described herein.

The communications manager 1520 may support wireless communications at an ambient-powered wireless device in accordance with examples as disclosed herein. The query message component 1525 is capable of, configured to, or operable to support a means for receiving a query message from a reader wireless device requesting that the ambient-powered wireless device report that the ambient-powered wireless device is associated with the reader wireless device. The query response component 1530 is capable of, configured to, or operable to support a means for transmitting, in response to the query message, a query response message to the reader wireless device, the query response message reporting that the ambient-powered wireless device is associated with the reader wireless device. The device association component 1535 is capable of, configured to, or operable to support a means for receiving a message from the reader wireless device based on the query response message indicating that the ambient-powered wireless device is associated with the reader wireless device.

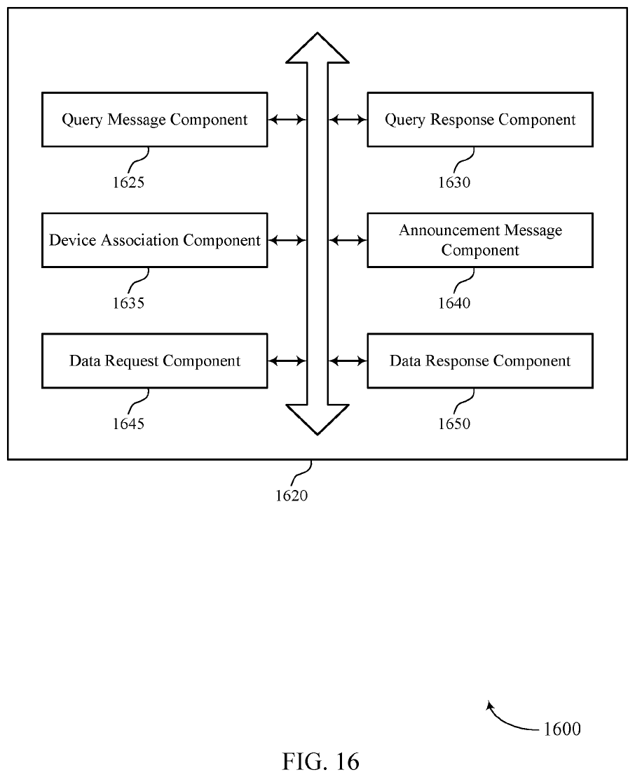

FIG. 16 shows a block diagram 1600 of a communications manager 1620 that supports mobility management for ambient-powered wireless devices in accordance with one or more aspects of the present disclosure. The communications manager 1620 may be an example of aspects of a communications manager 1420, a communications manager 1520, or both, as described herein. The communications manager 1620, or various components thereof, may be an example of means for performing various aspects of mobility management for ambient-powered wireless devices as described herein. For example, the communications manager 1620 may include a query message component 1625, a query response component 1630, a device association component 1635, an announcement message component 1640, a data request component 1645, a data response component 1650, or any combination thereof. Each of these components, or components or subcomponents thereof (e.g., one or more processors, one or more memories), may communicate, directly or indirectly, with one another (e.g., via one or more buses).

The communications manager 1620 may support wireless communications at an ambient-powered wireless device in accordance with examples as disclosed herein. The query message component 1625 is capable of, configured to, or operable to support a means for receiving a query message from a reader wireless device requesting that the ambient-powered wireless device report that the ambient-powered wireless device is associated with the reader wireless device. The query response component 1630 is capable of, configured to, or operable to support a means for transmitting, in response to the query message, a query response message to the reader wireless device, the query response message reporting that the ambient-powered wireless device is associated with the reader wireless device. The device association component 1635 is capable of, configured to, or operable to support a means for receiving a message from the reader wireless device based on the query response message indicating that the ambient-powered wireless device is associated with the reader wireless device.

In some examples, to support receiving the query message, the query message component 1625 is capable of, configured to, or operable to support a means for receiving the query message that requests information associated with the ambient-powered wireless device.

In some examples, to support transmitting the query response message, the query response component 1630 is capable of, configured to, or operable to support a means for transmitting, in response to the query message, the query response message identifying the information associated with the ambient-powered wireless device.

In some examples, the query message indicates to suspend transmission of the query response message by the ambient-powered wireless device for a time period ending based on a trigger.

In some examples, the query message component 1625 is capable of, configured to, or operable to support a means for receiving a second query message from a second reader wireless device requesting second information associated with the ambient-powered wireless device based on an environmental change.

In some examples, to support transmitting the query response message, the query response component 1630 is capable of, configured to, or operable to support a means for transmitting the query response message that is a backscattering of the query message.

In some examples, the announcement message component 1640 is capable of, configured to, or operable to support a means for transmitting an announcement message to the reader wireless device, the announcement message identifying information associated with the ambient-powered wireless device based on expiration of a timer.

In some examples, the data request component 1645 is capable of, configured to, or operable to support a means for receiving a request message from the reader wireless device requesting data for relay to a mobility function network entity. In some examples, the data response component 1650 is capable of, configured to, or operable to support a means for transmitting, in response to the request message, a response message to the reader wireless device identifying the data.

In some examples, the query message is received based on a movement of the one or more ambient-powered wireless devices, a movement of the reader wireless device, an environmental change, or a combination thereof.

In some examples, the query message component 1625 is capable of, configured to, or operable to support a means for transmitting an indication of a traffic profile associated with the ambient-powered wireless device, where receiving the query message is based on the traffic profile. In some examples, the query message includes a set of reporting parameters.

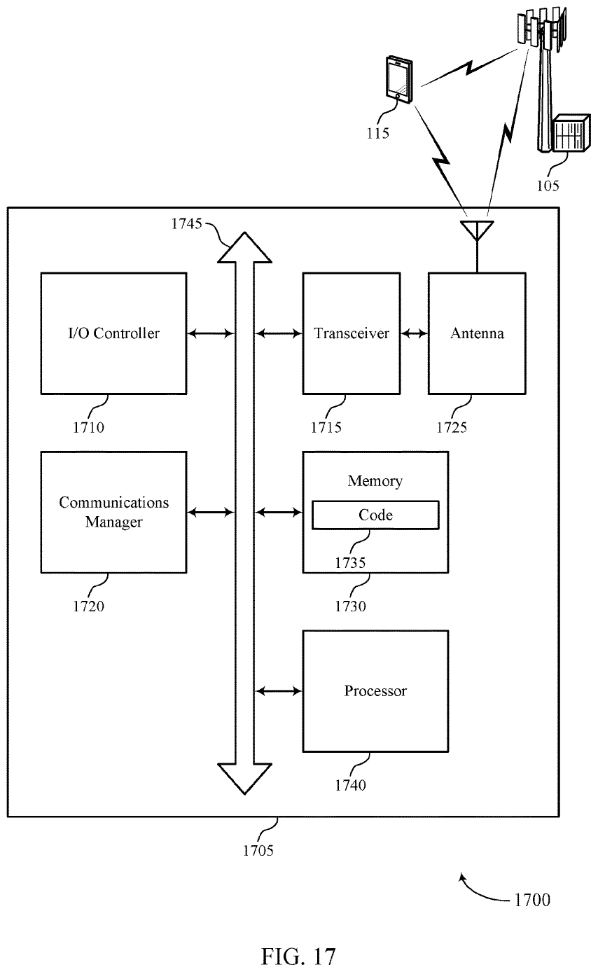

FIG. 17 shows a diagram of a system 1700 including a device 1705 that supports mobility management for ambient-powered wireless devices in accordance with one or more aspects of the present disclosure. The device 1705 may be an example of or include the components of a device 605, a device 705, or a mobility function network entity as described herein. The device 1705 may include components for bi-directional voice and data communications including components for transmitting and receiving communications, such as a communications manager 1720, an I/O controller 1710, a transceiver 1715, an antenna 1725, at least one memory 1730, code 1735, and at least one processor 1740. These components may be in electronic communication or otherwise coupled (e.g., operatively, communicatively, functionally, electronically, electrically) via one or more buses (e.g., a bus 1745).

The I/O controller 1710 may manage input and output signals for the device 1705. The I/O controller 1710 may also manage peripherals not integrated into the device 1705. In some cases, the I/O controller 1710 may represent a physical connection or port to an external peripheral. In some cases, the I/O controller 1710 may utilize an operating system such as iOS®, ANDROID®, MS-DOS®, MS-WINDOWS®, OS/2®, UNIX®, LINUX®, or another known operating system. Additionally, or alternatively, the I/O controller 1710 may represent or interact with a modem, a keyboard, a mouse, a touchscreen, or a similar device. In some cases, the I/O controller 1710 may be implemented as part of one or more processors, such as the at least one processor 1740. In some cases, a user may interact with the device 1705 via the I/O controller 1710 or via hardware components controlled by the I/O controller 1710.

In some cases, the device 1705 may include a single antenna 1725. However, in some other cases, the device 1705 may have more than one antenna 1725, which may be capable of concurrently transmitting or receiving multiple wireless transmissions. The transceiver 1715 may communicate bi-directionally, via the one or more antennas 1725, wired, or wireless links as described herein. For example, the transceiver 1715 may represent a wireless transceiver and may communicate bi-directionally with another wireless transceiver. The transceiver 1715 may also include a modem to modulate the packets, to provide the modulated packets to one or more antennas 1725 for transmission, and to demodulate packets received from the one or more antennas 1725. The transceiver 1715, or the transceiver 1715 and one or more antennas 1725, may be an example of a transmitter 615, a transmitter 715, a receiver 610, a receiver 710, or any combination thereof or component thereof, as described herein.

The at least one memory 1730 may include RAM and ROM. The at least one memory 1730 may store computer-readable, computer-executable code 1735 including instructions that, when executed by the at least one processor 1740, cause the device 1705 to perform various functions described herein. The code 1735 may be stored in a non-transitory computer-readable medium such as system memory or another type of memory. In some cases, the code 1735 may not be directly executable by the at least one processor 1740 but may cause a computer (e.g., when compiled and executed) to perform functions described herein. In some cases, the at least one memory 1730 may contain, among other things, a BIOS which may control basic hardware or software operation such as the interaction with peripheral components or devices.

The at least one processor 1740 may include an intelligent hardware device (e.g., a general-purpose processor, a DSP, a CPU, a GPU, a microcontroller, an ASIC, an FPGA, a programmable logic device, a discrete gate or transistor logic component, a discrete hardware component, or any combination thereof). In some cases, the at least one processor 1740 may be configured to operate a memory array using a memory controller. In some other cases, a memory controller may be integrated into the at least one processor 1740. The at least one processor 1740 may be configured to execute computer-readable instructions stored in a memory (e.g., the at least one memory 1730) to cause the device 1705 to perform various functions (e.g., functions or tasks supporting mobility management for ambient-powered wireless devices). For example, the device 1705 or a component of the device 1705 may include at least one processor 1740 and at least one memory 1730 coupled with or to the at least one processor 1740, the at least one processor 1740 and at least one memory 1730 configured to perform various functions described herein. In some examples, the at least one processor 1740 may include multiple processors and the at least one memory 1730 may include multiple memories. One or more of the multiple processors may be coupled with one or more of the multiple memories, which may, individually or collectively, be configured to perform various functions herein.

The communications manager 1720 may support wireless communications at an ambient-powered wireless device in accordance with examples as disclosed herein. For example, the communications manager 1720 is capable of, configured to, or operable to support a means for receiving a query message from a reader wireless device requesting that the ambient-powered wireless device report that the ambient-powered wireless device is associated with the reader wireless device. The communications manager 1720 is capable of, configured to, or operable to support a means for transmitting, in response to the query message, a query response message to the reader wireless device, the query response message reporting that the ambient-powered wireless device is associated with the reader wireless device. The communications manager 1720 is capable of, configured to, or operable to support a means for receiving a message from the reader wireless device based on the query response message indicating that the ambient-powered wireless device is associated with the reader wireless device.

By including or configuring the communications manager 1720 in accordance with examples as described herein, the device 1705 may support techniques for mobility management for ambient-powered wireless devices, which may support reduced power consumption, reduced processing, more efficient utilization of communication resources, improved coordination between devices, and improved reliability.

In some examples, the communications manager 1720 may be configured to perform various operations (e.g., receiving, monitoring, transmitting) using or otherwise in cooperation with the transceiver 1715, the one or more antennas 1725, or any combination thereof. Although the communications manager 1720 is illustrated as a separate component, in some examples, one or more functions described with reference to the communications manager 1720 may be supported by or performed by the at least one processor 1740, the at least one memory 1730, the code 1735, or any combination thereof. For example, the code 1735 may include instructions executable by the at least one processor 1740 to cause the device 1705 to perform various aspects of mobility management for ambient-powered wireless devices as described herein, or the at least one processor 1740 and the at least one memory 1730 may be otherwise configured to, individually or collectively, perform or support such operations.

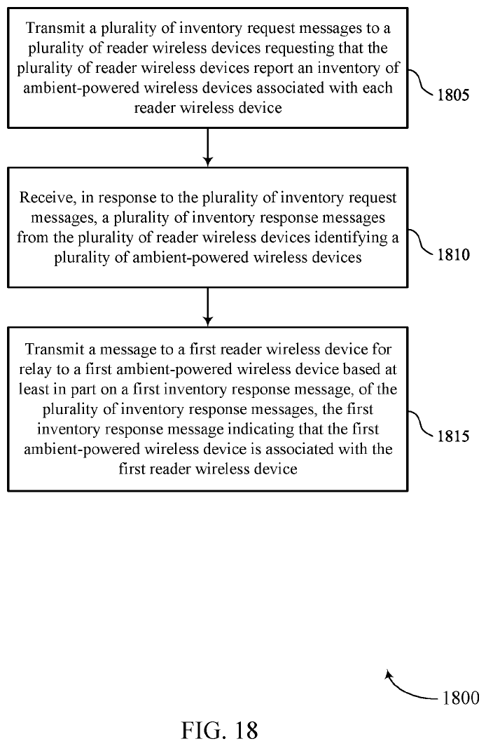

FIG. 18 shows a flowchart illustrating a method 1800 that supports mobility management for ambient-powered wireless devices in accordance with aspects of the present disclosure. The operations of the method 1800 may be implemented by a mobility function network entity or its components as described herein. For example, the operations of the method 1800 may be performed by a mobility function network entity as described with reference to FIGS. 1 through 9. In some examples, a mobility function network entity may execute a set of instructions to control the functional elements of the mobility function network entity to perform the described functions. Additionally, or alternatively, the mobility function network entity may perform aspects of the described functions using special-purpose hardware.

At 1805, the method may include transmitting a plurality of inventory request messages to a plurality of reader wireless devices requesting that the plurality of reader wireless devices report an inventory of ambient-powered wireless devices associated with each reader wireless device. The operations of 1805 may be performed in accordance with examples as disclosed herein. In some examples, aspects of the operations of 1805 may be performed by a request manager 825 as described with reference to FIG. 8.

At 1810, the method may include receiving, in response to the plurality of inventory request messages, a plurality of inventory response messages from the plurality of reader wireless devices identifying a plurality of ambient-powered wireless devices. The operations of 1810 may be performed in accordance with examples as disclosed herein. In some examples, aspects of the operations of 1810 may be performed by a response manager 830 as described with reference to FIG. 8.

At 1815, the method may include transmitting a message to a first reader wireless device for relay to a first ambient-powered wireless device based at least in part on a first inventory response message, of the plurality of inventory response messages, the first inventory response message indicating that the first ambient-powered wireless device is associated with the first reader wireless device. The operations of 1815 may be performed in accordance with examples as disclosed herein. In some examples, aspects of the operations of 1815 may be performed by a relay manager 835 as described with reference to FIG. 8.

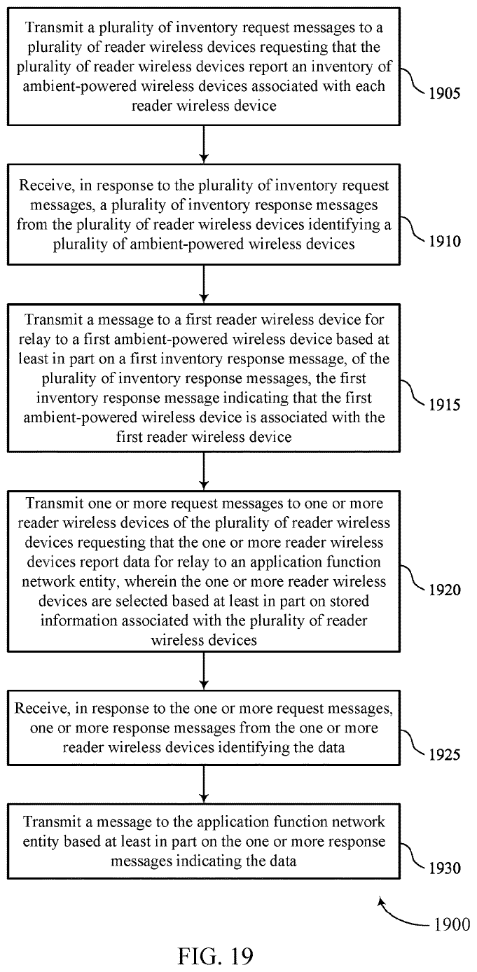

FIG. 19 shows a flowchart illustrating a method 1900 that supports mobility management for ambient-powered wireless devices in accordance with aspects of the present disclosure. The operations of the method 1900 may be implemented by a mobility function network entity or its components as described herein. For example, the operations of the method 1900 may be performed by a mobility function network entity as described with reference to FIGS. 1 through 9. In some examples, a mobility function network entity may execute a set of instructions to control the functional elements of the mobility function network entity to perform the described functions. Additionally, or alternatively, the mobility function network entity may perform aspects of the described functions using special-purpose hardware.

At 1905, the method may include transmitting a plurality of inventory request messages to a plurality of reader wireless devices requesting that the plurality of reader wireless devices report an inventory of ambient-powered wireless devices associated with each reader wireless device. The operations of 1905 may be performed in accordance with examples as disclosed herein. In some examples, aspects of the operations of 1905 may be performed by a request manager 825 as described with reference to FIG. 8.

At 1910, the method may include receiving, in response to the plurality of inventory request messages, a plurality of inventory response messages from the plurality of reader wireless devices identifying a plurality of ambient-powered wireless devices. The operations of 1910 may be performed in accordance with examples as disclosed herein. In some examples, aspects of the operations of 1910 may be performed by a response manager 830 as described with reference to FIG. 8.

At 1915, the method may include transmitting a message to a first reader wireless device for relay to a first ambient-powered wireless device based at least in part on a first inventory response message, of the plurality of inventory response messages, the first inventory response message indicating that the first ambient-powered wireless device is associated with the first reader wireless device. The operations of 1915 may be performed in accordance with examples as disclosed herein. In some examples, aspects of the operations of 1915 may be performed by a relay manager 835 as described with reference to FIG. 8.

At 1920, the method may include transmitting one or more request messages to one or more reader wireless devices of the plurality of reader wireless devices requesting that the one or more reader wireless devices report data for relay to an application function network entity, wherein the one or more reader wireless devices are selected based at least in part on stored information associated with the plurality of reader wireless devices. The operations of 1920 may be performed in accordance with examples as disclosed herein. In some examples, aspects of the operations of 1920 may be performed by a request manager 825 as described with reference to FIG. 8.

At 1925, the method may include receiving, in response to the one or more request messages, one or more response messages from the one or more reader wireless devices identifying the data. The operations of 1925 may be performed in accordance with examples as disclosed herein. In some examples, aspects of the operations of 1925 may be performed by a response manager 830 as described with reference to FIG. 8.

At 1930, the method may include transmitting a message to the application function network entity based at least in part on the one or more response messages indicating the data. The operations of 1930 may be performed in accordance with examples as disclosed herein. In some examples, aspects of the operations of 1930 may be performed by a relay manager 835 as described with reference to FIG. 8.

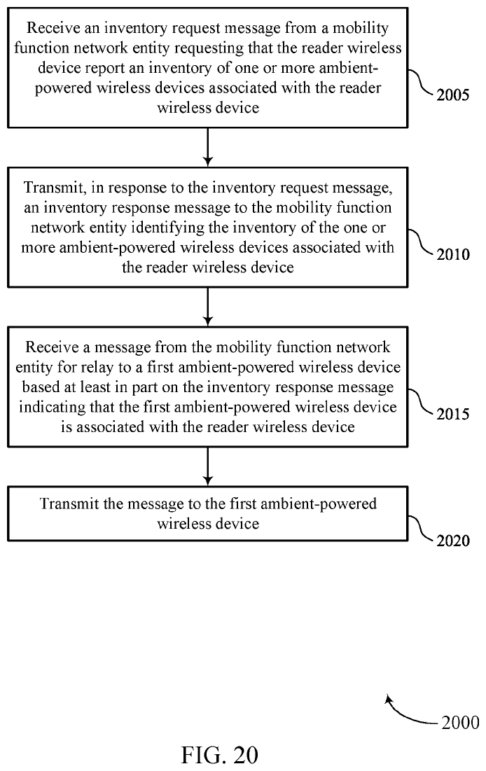

FIG. 20 shows a flowchart illustrating a method 2000 that supports mobility management for ambient-powered wireless devices in accordance with aspects of the present disclosure. The operations of the method 2000 may be implemented by a reader wireless device or its components as described herein. For example, the operations of the method 2000 may be performed by a reader wireless device as described with reference to FIGS. 1 through 5 and 10 through 13. In some examples, a reader wireless device may execute a set of instructions to control the functional elements of the reader wireless device to perform the described functions. Additionally, or alternatively, the reader wireless device may perform aspects of the described functions using special-purpose hardware.

At 2005, the method may include receiving an inventory request message from a mobility function network entity requesting that the reader wireless device report an inventory of one or more ambient-powered wireless devices associated with the reader wireless device. The operations of 2005 may be performed in accordance with examples as disclosed herein. In some examples, aspects of the operations of 2005 may be performed by an inventory request manager 1225 as described with reference to FIG. 12.

At 2010, the method may include transmitting, in response to the inventory request message, an inventory response message to the mobility function network entity identifying the inventory of the one or more ambient-powered wireless devices associated with the reader wireless device. The operations of 2010 may be performed in accordance with examples as disclosed herein. In some examples, aspects of the operations of 2010 may be performed by an inventory response manager 1230 as described with reference to FIG. 12.

At 2015, the method may include receiving a message from the mobility function network entity for relay to a first ambient-powered wireless device based at least in part on the inventory response message indicating that the first ambient-powered wireless device is associated with the reader wireless device. The operations of 2015 may be performed in accordance with examples as disclosed herein. In some examples, aspects of the operations of 2015 may be performed by a relay message manager 1235 as described with reference to FIG. 12.

At 2020, the method may include transmitting the message to the first ambient-powered wireless device. The operations of 2020 may be performed in accordance with examples as disclosed herein. In some examples, aspects of the operations of 2020 may be performed by a message manager 1240 as described with reference to FIG. 12.

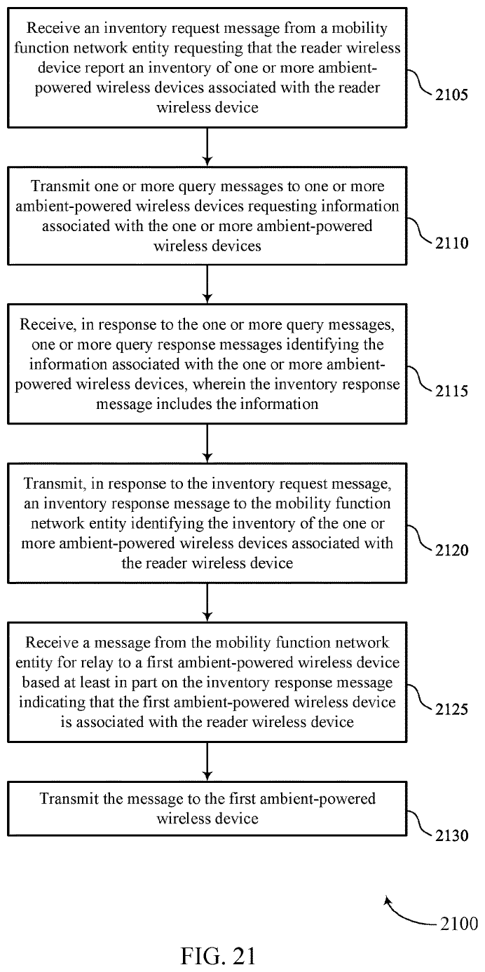

FIG. 21 shows a flowchart illustrating a method 2100 that supports mobility management for ambient-powered wireless devices in accordance with aspects of the present disclosure. The operations of the method 2100 may be implemented by a reader wireless device or its components as described herein. For example, the operations of the method 2100 may be performed by a reader wireless device as described with reference to FIGS. 1 through 5 and 10 through 13. In some examples, a reader wireless device may execute a set of instructions to control the functional elements of the reader wireless device to perform the described functions. Additionally, or alternatively, the reader wireless device may perform aspects of the described functions using special-purpose hardware.

At 2105, the method may include receiving an inventory request message from a mobility function network entity requesting that the reader wireless device report an inventory of one or more ambient-powered wireless devices associated with the reader wireless device. The operations of 2105 may be performed in accordance with examples as disclosed herein. In some examples, aspects of the operations of 2105 may be performed by an inventory request manager 1225 as described with reference to FIG. 12.

At 2110, the method may include transmitting one or more query messages to one or more ambient-powered wireless devices requesting information associated with the one or more ambient-powered wireless devices. The operations of 2110 may be performed in accordance with examples as disclosed herein. In some examples, aspects of the operations of 2110 may be performed by a query message manager 1245 as described with reference to FIG. 12.

At 2115, the method may include receiving, in response to the one or more query messages, one or more query response messages identifying the information associated with the one or more ambient-powered wireless devices, wherein the inventory response message includes the information. The operations of 2115 may be performed in accordance with examples as disclosed herein. In some examples, aspects of the operations of 2115 may be performed by a query message manager 1245 as described with reference to FIG. 12.

At 2120, the method may include transmitting, in response to the inventory request message, an inventory response message to the mobility function network entity identifying the inventory of the one or more ambient-powered wireless devices associated with the reader wireless device. The operations of 2120 may be performed in accordance with examples as disclosed herein. In some examples, aspects of the operations of 2120 may be performed by an inventory response manager 1230 as described with reference to FIG. 12.

At 2125, the method may include receiving a message from the mobility function network entity for relay to a first ambient-powered wireless device based at least in part on the inventory response message indicating that the first ambient-powered wireless device is associated with the reader wireless device. The operations of 2125 may be performed in accordance with examples as disclosed herein. In some examples, aspects of the operations of 2125 may be performed by a relay message manager 1235 as described with reference to FIG. 12.

At 2130, the method may include transmitting the message to the first ambient-powered wireless device. The operations of 2130 may be performed in accordance with examples as disclosed herein. In some examples, aspects of the operations of 2130 may be performed by a message manager 1240 as described with reference to FIG. 12.

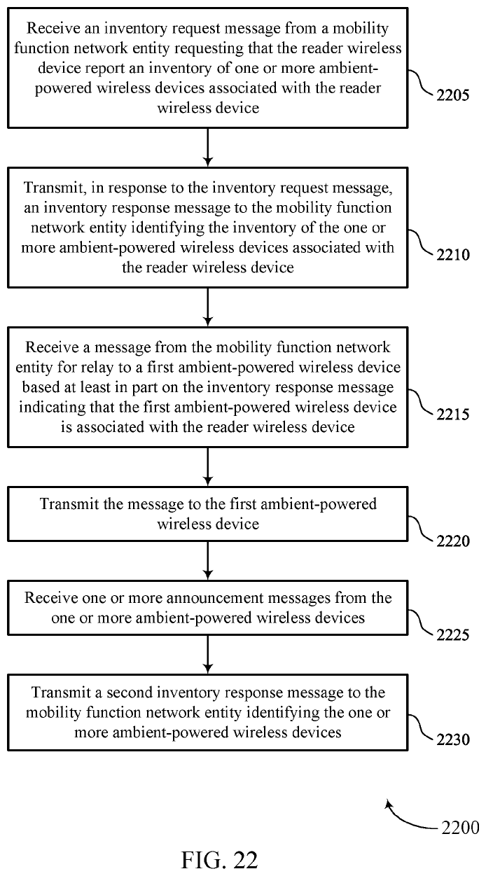

FIG. 22 shows a flowchart illustrating a method 2200 that supports mobility management for ambient-powered wireless devices in accordance with aspects of the present disclosure. The operations of the method 2200 may be implemented by a reader wireless device or its components as described herein. For example, the operations of the method 2200 may be performed by a reader wireless device as described with reference to FIGS. 1 through 5 and 10 through 13. In some examples, a reader wireless device may execute a set of instructions to control the functional elements of the reader wireless device to perform the described functions. Additionally, or alternatively, the reader wireless device may perform aspects of the described functions using special-purpose hardware.

At 2205, the method may include receiving an inventory request message from a mobility function network entity requesting that the reader wireless device report an inventory of one or more ambient-powered wireless devices associated with the reader wireless device. The operations of 2205 may be performed in accordance with examples as disclosed herein. In some examples, aspects of the operations of 2205 may be performed by an inventory request manager 1225 as described with reference to FIG. 12.

At 2210, the method may include transmitting, in response to the inventory request message, an inventory response message to the mobility function network entity identifying the inventory of the one or more ambient-powered wireless devices associated with the reader wireless device. The operations of 2210 may be performed in accordance with examples as disclosed herein. In some examples, aspects of the operations of 2210 may be performed by an inventory response manager 1230 as described with reference to FIG. 12.

At 2215, the method may include receiving a message from the mobility function network entity for relay to a first ambient-powered wireless device based at least in part on the inventory response message indicating that the first ambient-powered wireless device is associated with the reader wireless device. The operations of 2215 may be performed in accordance with examples as disclosed herein. In some examples, aspects of the operations of 2215 may be performed by a relay message manager 1235 as described with reference to FIG. 12.

At 2220, the method may include transmitting the message to the first ambient-powered wireless device. The operations of 2220 may be performed in accordance with examples as disclosed herein. In some examples, aspects of the operations of 2220 may be performed by a message manager 1240 as described with reference to FIG. 12.

At 2225, the method may include receiving one or more announcement messages from the one or more ambient-powered wireless devices. The operations of 2225 may be performed in accordance with examples as disclosed herein. In some examples, aspects of the operations of 2225 may be performed by an announcement message manager 1250 as described with reference to FIG. 12.

At 2230, the method may include transmitting a second inventory response message to the mobility function network entity identifying the one or more ambient-powered wireless devices. The operations of 2230 may be performed in accordance with examples as disclosed herein. In some examples, aspects of the operations of 2230 may be performed by an inventory response manager 1230 as described with reference to FIG. 12.

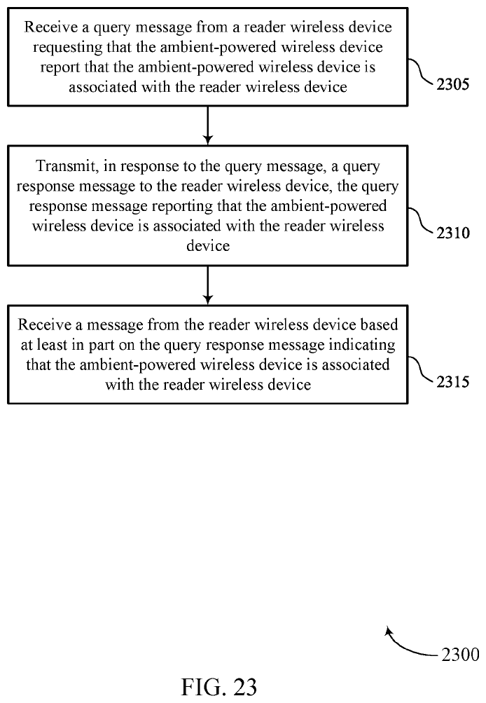

FIG. 23 shows a flowchart illustrating a method 2300 that supports mobility management for ambient-powered wireless devices in accordance with aspects of the present disclosure. The operations of the method 2300 may be implemented by an ambient-powered wireless device or its components as described herein. For example, the operations of the method 2300 may be performed by an ambient-powered wireless device as described with reference to FIGS. 1 through 5 and 13 through 17. In some examples, an ambient-powered wireless device may execute a set of instructions to control the functional elements of the ambient-powered wireless device to perform the described functions. Additionally, or alternatively, the ambient-powered wireless device may perform aspects of the described functions using special-purpose hardware.

At 2305, the method may include receiving a query message from a reader wireless device requesting that the ambient-powered wireless device report that the ambient-powered wireless device is associated with the reader wireless device. The operations of 2305 may be performed in accordance with examples as disclosed herein. In some examples, aspects of the operations of 2305 may be performed by a query message component 1625 as described with reference to FIG. 16.

At 2310, the method may include transmitting, in response to the query message, a query response message to the reader wireless device, the query response message reporting that the ambient-powered wireless device is associated with the reader wireless device. The operations of 2310 may be performed in accordance with examples as disclosed herein. In some examples, aspects of the operations of 2310 may be performed by a query response component 1630 as described with reference to FIG. 16.

At 2315, the method may include receiving a message from the reader wireless device based at least in part on the query response message indicating that the ambient-powered wireless device is associated with the reader wireless device. The operations of 2315 may be performed in accordance with examples as disclosed herein. In some examples, aspects of the operations of 2315 may be performed by a device association component 1635 as described with reference to FIG. 16.

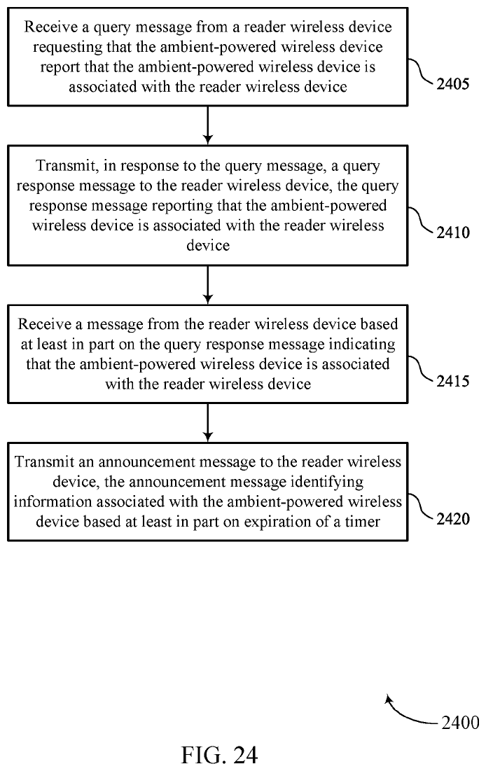

FIG. 24 shows a flowchart illustrating a method 2400 that supports mobility management for ambient-powered wireless devices in accordance with aspects of the present disclosure. The operations of the method 2400 may be implemented by an ambient-powered wireless device or its components as described herein. For example, the operations of the method 2400 may be performed by an ambient-powered wireless device as described with reference to FIGS. 1 through 5 and 13 through 17. In some examples, an ambient-powered wireless device may execute a set of instructions to control the functional elements of the ambient-powered wireless device to perform the described functions. Additionally, or alternatively, the ambient-powered wireless device may perform aspects of the described functions using special-purpose hardware.

At 2405, the method may include receiving a query message from a reader wireless device requesting that the ambient-powered wireless device report that the ambient-powered wireless device is associated with the reader wireless device. The operations of 2405 may be performed in accordance with examples as disclosed herein. In some examples, aspects of the operations of 2405 may be performed by a query message component 1625 as described with reference to FIG. 16.

At 2410, the method may include transmitting, in response to the query message, a query response message to the reader wireless device, the query response message reporting that the ambient-powered wireless device is associated with the reader wireless device. The operations of 2410 may be performed in accordance with examples as disclosed herein. In some examples, aspects of the operations of 2410 may be performed by a query response component 1630 as described with reference to FIG. 16.

At 2415, the method may include receiving a message from the reader wireless device based at least in part on the query response message indicating that the ambient-powered wireless device is associated with the reader wireless device. The operations of 2415 may be performed in accordance with examples as disclosed herein. In some examples, aspects of the operations of 2415 may be performed by a device association component 1635 as described with reference to FIG. 16.

At 2420, the method may include transmitting an announcement message to the reader wireless device, the announcement message identifying information associated with the ambient-powered wireless device based at least in part on expiration of a timer. The operations of 2420 may be performed in accordance with examples as disclosed herein. In some examples, aspects of the operations of 2420 may be performed by an announcement message component 1640 as described with reference to FIG. 16.

The following provides an overview of aspects of the present disclosure:
Aspect 1: A method for wireless communications at a mobility function network entity, comprising: transmitting a plurality of inventory request messages to a plurality of reader wireless devices requesting that the plurality of reader wireless devices report an inventory of ambient-powered wireless devices associated with each reader wireless device; receiving, in response to the plurality of inventory request messages, a plurality of inventory response messages from the plurality of reader wireless devices identifying a plurality of ambient-powered wireless devices; and transmitting a message to a first reader wireless device for relay to a first ambient-powered wireless device based at least in part on a first inventory response message, of the plurality of inventory response messages, the first inventory response message indicating that the first ambient-powered wireless device is associated with the first reader wireless device.
Aspect 2: The method of aspect 1, further comprising: receiving, based at least in part on a plurality of reflected messages of the plurality of ambient-powered wireless devices, the plurality of inventory response messages from the plurality of reader wireless devices identifying the plurality of ambient-powered wireless devices.
Aspect 3: The method of any of aspects 1 through 2, further comprising: receiving, based at least in part on a plurality of announcement messages of the plurality of ambient-powered wireless devices, a plurality of second inventory response messages from the plurality of reader wireless devices identifying the plurality of ambient-powered wireless devices.
Aspect 4: The method of any of aspects 1 through 3, further comprising: transmitting one or more request messages to one or more reader wireless devices of the plurality of reader wireless devices requesting that the one or more reader wireless devices report data for relay to an application function network entity, wherein the one or more reader wireless devices are selected based at least in part on stored information associated with the plurality of reader wireless devices; receiving, in response to the one or more request messages, one or more response messages from the one or more reader wireless devices identifying the data; and transmitting a message to the application function network entity based at least in part on the one or more response messages indicating the data.
Aspect 5: The method of aspect 4, wherein the one or more reader wireless devices are selected based at least in part on a distance or signal strength between the one or more reader wireless devices and one or more of the plurality of ambient-powered wireless devices.
Aspect 6: The method of any of aspects 1 through 5, further comprising: transmitting a message to an application function network entity indicating a location of the first reader wireless device, a location of the first ambient-powered wireless device, or both.
Aspect 7: The method of any of aspects 1 through 6, further comprising: storing information associated with the identified plurality of ambient-powered wireless devices based at least in part on the plurality of inventory response messages.
Aspect 8: The method of any of aspects 1 through 7, wherein the plurality of inventory request messages indicate to suspend transmission of one or more of the plurality of inventory response messages by one or more the plurality of reader wireless devices for a time period or based at least in part on a trigger.
Aspect 9: The method of any of aspects 1 through 8, wherein the plurality of inventory response messages indicate a plurality of locations of the plurality of reader wireless devices, a plurality of reader wireless device IDs, and a plurality of ambient-powered wireless device IDs.
Aspect 10: The method of any of aspects 1 through 9, wherein transmitting one or more of the plurality of inventory request messages is based at least in part on a traffic profile associated with one or more of the plurality of ambient-powered wireless devices.
Aspect 11: The method of any of aspects 1 through 10, further comprising: storing a set of information associated with the identified plurality of ambient-powered wireless devices, wherein the set of information includes power characteristics, energy storage capabilities, mobility characteristics, or any combination thereof.
Aspect 12: The method of any of aspects 1 through 11, wherein the plurality of inventory request messages comprise a set of reporting parameters.
Aspect 13: A method for wireless communications at a reader wireless device, comprising: receiving an inventory request message from a mobility function network entity requesting that the reader wireless device report an inventory of one or more ambient-powered wireless devices associated with the reader wireless device; transmitting, in response to the inventory request message, an inventory response message to the mobility function network entity identifying the inventory of the one or more ambient-powered wireless devices associated with the reader wireless device; receiving a message from the mobility function network entity for relay to a first ambient-powered wireless device based at least in part on the inventory response message indicating that the first ambient-powered wireless device is associated with the reader wireless device; and transmitting the message to the first ambient-powered wireless device.
Aspect 14: The method of aspect 13, further comprising: transmitting one or more query messages to one or more ambient-powered wireless devices requesting information associated with the one or more ambient-powered wireless devices.
Aspect 15: The method of aspect 14, wherein transmitting the one or more query messages to the one or more ambient-powered wireless devices is based at least in part on a movement of the reader wireless device, a movement of the one or more ambient-powered wireless devices, an environmental change, or a combination thereof.
Aspect 16: The method of any of aspects 14 through 15, further comprising: receiving, in response to the one or more query messages, one or more query response messages identifying the information associated with the one or more ambient-powered wireless devices, wherein the inventory response message includes the information.
Aspect 17: The method of aspect 16, wherein the one or more query messages indicate to suspend transmission of the one or more query response messages by the one or more ambient-powered wireless devices for a time period or based at least in part on a trigger.
Aspect 18: The method of any of aspects 13 through 17, further comprising: receiving one or more reflected messages from the one or more ambient-powered wireless devices; and transmitting the inventory response message in response to receiving the one or more reflected messages.
Aspect 19: The method of any of aspects 13 through 18, further comprising: receiving one or more announcement messages from the one or more ambient-powered wireless devices; and transmitting a second inventory response message to the mobility function network entity identifying the one or more ambient-powered wireless devices.
Aspect 20: The method of any of aspects 13 through 19, further comprising: receiving a first request message from the mobility function network entity requesting that the reader wireless device reports data for relay to an application function network entity; transmitting, in response to the first request message, one or more second request messages to the one or more ambient-powered wireless devices requesting the data; receiving, in response to the one or more second request messages, one or more first response messages from the one or more ambient-powered wireless devices identifying the data; and transmitting, in response to the one or more first response messages, a response message identifying the data.
Aspect 21: The method of aspect 20, wherein the first request message is received based at least in part on a distance or signal strength between the reader wireless device and the one or more ambient-powered wireless devices.
Aspect 22: The method of any of aspects 13 through 21, wherein the inventory request message indicates to suspend transmission of the inventory response message by the reader wireless device for a time period or based at least in part on a trigger.
Aspect 23: The method of any of aspects 13 through 22, wherein the inventory request message indicates a location of the reader wireless device, a reader wireless device ID, and one or more ambient-powered wireless device IDs.
Aspect 24: The method of any of aspects 13 through 23, further comprising: receiving an indication of a traffic profile associated with the one or more ambient-powered wireless devices, wherein receiving the inventory request message is based at least in part on the traffic profile.
Aspect 25: The method of any of aspects 13 through 24, wherein the inventory request message comprises a set of reporting parameters.
Aspect 26: A method for wireless communications at an ambient-powered wireless device, comprising: receiving a query message from a reader wireless device requesting that the ambient-powered wireless device report that the ambient-powered wireless device is associated with the reader wireless device; transmitting, in response to the query message, a query response message to the reader wireless device, the query response message reporting that the ambient-powered wireless device is associated with the reader wireless device; and receiving a message from the reader wireless device based at least in part on the query response message indicating that the ambient-powered wireless device is associated with the reader wireless device.
Aspect 27: The method of aspect 26, wherein receiving the query message comprises: receiving the query message that requests information associated with the ambient-powered wireless device.
Aspect 28: The method of aspect 27, wherein transmitting the query response message comprises: transmitting, in response to the query message, the query response message identifying the information associated with the ambient-powered wireless device.
Aspect 29: The method of any of aspects 26 through 28, wherein the query message indicates to suspend transmission of the query response message by the ambient-powered wireless device for a time period ending based at least in part on a trigger.
Aspect 30: The method of any of aspects 26 through 29, further comprising: receiving a second query message from a second reader wireless device requesting second information associated with the ambient-powered wireless device based at least in part on an environmental change.
Aspect 31: The method of any of aspects 26 through 30, wherein transmitting the query response message further comprises: transmitting the query response message that is a backscattering of the query message.
Aspect 32: The method of any of aspects 26 through 31, further comprising: transmitting an announcement message to the reader wireless device, the announcement message identifying information associated with the ambient-powered wireless device based at least in part on expiration of a timer.
Aspect 33: The method of any of aspects 26 through 32, further comprising: receiving a request message from the reader wireless device requesting data for relay to a mobility function network entity; and transmitting, in response to the request message, a response message to the reader wireless device identifying the data.
Aspect 34: The method of any of aspects 26 through 33, wherein the query message is received based at least in part on a movement of the one or more ambient-powered wireless devices, a movement of the reader wireless device, an environmental change, or a combination thereof.
Aspect 35: The method of any of aspects 26 through 34, further comprising; transmitting an indication of a traffic profile associated with the ambient-powered wireless device, wherein receiving the query message is based at least in part on the traffic profile.
Aspect 36: The method of any of aspects 26 through 35, wherein the query message comprises a set of reporting parameters.
Aspect 37: An apparatus for wireless communications at a mobility function network entity, comprising at least one processor; memory coupled (e.g., operatively, communicatively, functionally, electronically, or electrically) with the at least one processor; and instructions stored in the memory and executable by the at least one processor (e.g., directly, indirectly, after pre-processing, without pre-processing) to cause the apparatus to perform a method of any of aspects 1 through 12.
Aspect 38: An apparatus for wireless communications at a mobility function network entity, comprising at least one means for performing a method of any of aspects 1 through 12.
Aspect 39: A non-transitory computer-readable medium storing code for wireless communications at a mobility function network entity, the code comprising instructions executable by at least one processor (e.g., directly, indirectly, after pre-processing, without pre-processing) to perform a method of any of aspects 1 through 12.
Aspect 40: An apparatus for wireless communications at a reader wireless device, comprising at least one processor; memory coupled (e.g., operatively, communicatively, functionally, electronically, or electrically) with the at least one processor; and instructions stored in the memory and executable by the at least one processor (e.g., directly, indirectly, after pre-processing, without pre-processing) to cause the apparatus to perform a method of any of aspects 13 through 25.
Aspect 41: An apparatus for wireless communications at a reader wireless device, comprising at least one means for performing a method of any of aspects 13through 25.
Aspect 42: A non-transitory computer-readable medium storing code for wireless communications at a reader wireless device, the code comprising instructions executable by at least one processor (e.g., directly, indirectly, after pre-processing, without pre-processing) to perform a method of any of aspects 13 through 25.
Aspect 43: An apparatus for wireless communications at an ambient-powered wireless device, comprising at least one processor; memory coupled (e.g., operatively, communicatively, functionally, electronically, or electrically) with the at least one processor; and instructions stored in the memory and executable by the at least one processor (e.g., directly, indirectly, after pre-processing, without pre-processing) to cause the apparatus to perform a method of any of aspects 26 through 36.
Aspect 44: An apparatus for wireless communications at an ambient-powered wireless device, comprising at least one means for performing a method of any of aspects 26 through 36.
p Aspect 45: A non-transitory computer-readable medium storing code for wireless communications at an ambient-powered wireless device, the code comprising instructions executable by at least one processor (e.g., directly, indirectly, after pre-processing, without pre-processing) to perform a method of any of aspects 26 through 36.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies, including future systems and radio technologies, not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a GPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, or any combination thereof. Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, firmware, middleware, microcode, hardware description language, or otherwise. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, phase change memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., including a list of items prefaced by a phrase such as “at least one of” or “one or more of”) indicates an inclusive list such that, for example, a list of at least one of A, B, or C means, e.g., A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” or “identify” or “identifying” encompasses a variety of actions and, therefore, “determining” or “identifying” can include calculating, computing, processing, deriving, investigating, looking up (such as via looking up in a table, a database or another data structure), ascertaining and the like. Also, “determining” or “identifying” can include receiving (such as receiving information or signaling, e.g., receiving information or signaling for determining, receiving information or signaling for identifying), accessing (such as accessing data in a memory, or accessing information) and the like. Also, “determining” or “identifying” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. An apparatus for wireless communications at a mobility function network entity, comprising:
at least one processor; and
memory coupled with the at least one processor, the memory storing instructions executable by the at least one processor to cause the mobility function network entity to:
transmit a plurality of inventory request messages to a plurality of reader wireless devices requesting that the plurality of reader wireless devices report an inventory of ambient-powered wireless devices associated with each reader wireless device;
receive, in response to the plurality of inventory request messages, a plurality of inventory response messages from the plurality of reader wireless devices identifying a plurality of ambient-powered wireless devices; and
transmit a message to a first reader wireless device for relay to a first ambient-powered wireless device based at least in part on a first inventory response message, of the plurality of inventory response messages, the first inventory response message indicating that the first ambient-powered wireless device is associated with the first reader wireless device.

2. The apparatus of claim 1, wherein the instructions are further executable by the at least one processor to cause the mobility function network entity to:
receive, based at least in part on a plurality of reflected messages of the plurality of ambient-powered wireless devices, the plurality of inventory response messages from the plurality of reader wireless devices identifying the plurality of ambient-powered wireless devices.

3. The apparatus of claim 1, wherein the instructions are further executable by the at least one processor to cause the mobility function network entity to:
receive, based at least in part on a plurality of announcement messages of the plurality of ambient-powered wireless devices, a plurality of second inventory response messages from the plurality of reader wireless devices identifying the plurality of ambient-powered wireless devices.

4. The apparatus of claim 1, wherein the instructions are further executable by the at least one processor to cause the mobility function network entity to:
transmit one or more request messages to one or more reader wireless devices of the plurality of reader wireless devices requesting that the one or more reader wireless devices report data for relay to an application function network entity, wherein the one or more reader wireless devices are selected based at least in part on stored information associated with the plurality of reader wireless devices;
receive, in response to the one or more request messages, one or more response messages from the one or more reader wireless devices identifying the data; and
transmit a message to the application function network entity based at least in part on the one or more response messages indicating the data.

5. The apparatus of claim 4, wherein the one or more reader wireless devices are selected based at least in part on a distance or signal strength between the one or more reader wireless devices and one or more of the plurality of ambient-powered wireless devices.

6. The apparatus of claim 1, wherein the instructions are further executable by the at least one processor to cause the mobility function network entity to:
transmit a message to an application function network entity indicating a location of the first reader wireless device, a location of the first ambient-powered wireless device, or both.

7. The apparatus of claim 1, wherein the instructions are further executable by the at least one processor to cause the mobility function network entity to:
store information associated with the identified plurality of ambient-powered wireless devices based at least in part on the plurality of inventory response messages.

8. The apparatus of claim 1, wherein the plurality of inventory request messages indicate to suspend transmission of one or more of the plurality of inventory response messages by one or more the plurality of reader wireless devices for a time period or based at least in part on a trigger.

9. The apparatus of claim 1, wherein the plurality of inventory response messages indicate a plurality of locations of the plurality of reader wireless devices, a plurality of reader wireless device identifiers, and a plurality of ambient-powered wireless device identifiers.

10. The apparatus of claim 1, wherein transmitting one or more of the plurality of inventory request messages is based at least in part on a traffic profile associated with one or more of the plurality of ambient-powered wireless devices.

11. The apparatus of claim 1, wherein the instructions are further executable by the at least one processor to cause the mobility function network entity to:
store a set of information associated with the identified plurality of ambient-powered wireless devices, wherein the set of information includes power characteristics, energy storage capabilities, mobility characteristics, or any combination thereof.

12. The apparatus of claim 1, wherein the plurality of inventory request messages comprise a set of reporting parameters.

13. An apparatus for wireless communications at a reader wireless device, comprising:
at least one processor; and
memory coupled with the at least one processor, the memory storing instructions executable by the at least one processor to cause the reader wireless device to:
receive an inventory request message from a mobility function network entity requesting that the reader wireless device report an inventory of one or more ambient-powered wireless devices associated with the reader wireless device;
transmit, in response to the inventory request message, an inventory response message to the mobility function network entity identifying the inventory of the one or more ambient-powered wireless devices associated with the reader wireless device;
receive a message from the mobility function network entity for relay to a first ambient-powered wireless device based at least in part on the inventory response message indicating that the first ambient-powered wireless device is associated with the reader wireless device; and
transmit the message to the first ambient-powered wireless device.

14. The apparatus of claim 13, wherein the instructions are further executable by the at least one processor to cause the reader wireless device to:
transmit one or more query messages to one or more ambient-powered wireless devices requesting information associated with the one or more ambient-powered wireless devices.

15. The apparatus of claim 14, wherein transmitting the one or more query messages to the one or more ambient-powered wireless devices is based at least in part on a movement of the reader wireless device, a movement of the one or more ambient-powered wireless devices, an environmental change, or a combination thereof.

16. The apparatus of claim 14, wherein the instructions are further executable by the at least one processor to cause the reader wireless device to:
receive, in response to the one or more query messages, one or more query response messages identifying the information associated with the one or more ambient-powered wireless devices, wherein the inventory response message includes the information.

17. The apparatus of claim 16, wherein the one or more query messages indicate to suspend transmission of the one or more query response messages by the one or more ambient-powered wireless devices for a time period or based at least in part on a trigger.

18. The apparatus of claim 13, wherein the instructions are further executable by the at least one processor to cause the reader wireless device to:
receive one or more reflected messages from the one or more ambient-powered wireless devices; and
transmit the inventory response message in response to receiving the one or more reflected messages.

19.-21. (canceled)

22. An apparatus for wireless communications at an ambient-powered wireless device, comprising:
at least one processor; and
memory coupled with the at least one processor, the memory storing instructions executable by the at least one processor to cause the ambient-powered wireless device to:
receive a query message from a reader wireless device requesting that the ambient-powered wireless device report that the ambient-powered wireless device is associated with the reader wireless device;
transmit, in response to the query message, a query response message to the reader wireless device, the query response message reporting that the ambient-powered wireless device is associated with the reader wireless device; and
receive a message from the reader wireless device based at least in part on the query response message indicating that the ambient-powered wireless device is associated with the reader wireless device.

23. The apparatus of claim 22, wherein the instructions to receive the query message are executable by the at least one processor to cause the ambient-powered wireless device to:
receive the query message that requests information associated with the ambient-powered wireless device.

24.-30. (canceled)
